(19) United States
(12) Patent Application Publication
(10) Pub. No.: US 2005/0216384 A1
(43) Pub. Date: Sep. 29, 2005

(54) System, method, and computer program for creating and valuing financial instruments linked to real estate indices

(76) Inventors: Daniel Partlow, Westport, CT (US); Kam Haq, New York, NY (US); Maria Mejevitch, Westport, CT (US); Sean O'Malley, New York, NY (US)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/736,058

(22) Filed: Dec. 15, 2003

(51) Int. Cl. G06F 17/60

(52) U.S. Cl. 705/35

(57) ABSTRACT

A system, method and computer program for creating and valuing financial instruments (including but not limited to futures, forwards, call options, put options, swaps, “swaptions”, and “op-swaps”) linked to published real estate indices. The present invention will be referred to in this application as a real estate index linked financial instrument, and is defined as a financial instrument whose value changes based on movements in underlying indices based on real estate prices. These indices are published by sovereign governments, government-chartered agencies and departments (such as Fannie Mae, Freddie Mac, Office of Management and Budget, and the Treasury Department in the U.S.), non-governmental organizations, commercial banks, investment banks, realty agencies and many other organizations. The instruments can be written, with a published index number from any real estate index or indices as the initial value upon which the financial instrument's terms are based. The predicted future value of the real estate index or indices will change in response to market buy/sell demand based on investor expectations of the predicted future value of the real estate index or indices related to one or more real estate index linked financial instrument(s). Thus, the predicted future value of the index or indices will change in response to the market demand as investors offer to buy and/or sell real estate index linked financial instruments which will be listed on securities exchanges and electronic commerce networks (ECNs) as well as over the counter (OTC) and in private transactions. Each predicted future index value will change based on the investor expectation of how strong demand will be for the underlying real estate market upon which each index or indices are based. Thus, the present invention gives investors a means of taking or adjusting positions upon price movements in local, city, regional, state, national, or multinational/international real estate markets. It is important to note that real estate index linked financial instruments can be created either in standardized contract sizes that can be traded on futures, options or other securities exchanges, ECNs and/or OTC, or can be customized to meet the specifications of a transactional counterparty which wishes to speculate on movements in local, city, regional, state, national, or multinational/international real estate prices. Such instruments may also be created from a plurality of indices, thus allowing an investor to package movements from several different real estate indices into a single financial instrument. Such instruments may also involve a combination of real estate index linked financial instruments, either with each other or with other financial instruments in a combination containing at least one real estate index linked financial instrument.

### TECHNICAL FIELD

The present invention relates generally to financial trading systems and more particularly to the creation, identification, processing, trading, quotation, and valuation of real estate index linked financial instruments such as derivatives and the like.

### BACKGROUND OF THE INVENTION

Related Art

In today's financial markets, the use of financial instruments known as “derivatives” have exponentially grown and is now commonplace. A derivative is an investment vehicle whose value is based on the value of another security or underlying asset. That is, a derivative is essentially a financial instrument that is derived from the future movement of something that cannot be predicted with certainty. By the late 1990s the Office of the Comptroller of the Currency estimates that commercial banks in the United States alone held over twenty trillion dollars worth of derivative-based assets. Common examples of derivatives include futures contracts, forward contracts, options, and swaps, all of which are briefly explained below. Derivatives are described in detail in a variety of publicly available documents, such as Morris, Kenneth, The Wall Street Journal's Guide To Understanding Money & Investing, Lightbulb Press and Dow Jones & Co. Inc., ISBN: 0684869020, which is incorporated herein by reference in its entirety.

Options contracts are agreements that may be exchange-traded among two parties. Options represent the right to buy or sell a specified amount of an underlying security (e.g. a stock, bond, index, futures contract, etc.) at a specified price within a specified period of time. The parties of options contracts are buyers/purchasers/holders who acquire “rights,” and writers/sellers who assume “obligations.” Further, a “call” option contract is one giving the owner the right to buy at a specified price within a specified period of time, whereas a “put” option contract is one giving the owner the right to sell at a specified price within a specified period of time. There is typically an up-front, non-refundable premium that the buyer pays the seller to obtain the option rights. Note that for every option buyer there is an option seller. In other words, for every call buyer there is a call seller; for every put buyer, a put seller.

Forward and futures contracts are standardized, transferable agreements, which may be exchange-traded, to buy or sell a commodity (e.g. a particular crop, livestock, oil, gas, etc.). These contracts typically involve an agreed-upon place and time in the future between two parties, and lock in a price per unit at which delivery or settlement takes place.

Futures markets have been described as continuous auction markets and as clearing houses for the latest information about supply and demand. They are the meeting places of buyers and sellers of an ever-expanding list of commodities that today includes agricultural products, metals, petroleum, financial instruments, foreign currencies and stock indexes. As new supply and demand developments occur and as new and more current information becomes available, these judgments are reassessed and the price of a particular futures contract may be bid upward or downward. The process of reassessment—of price discovery—is continuous. There are two types of futures contracts, those that provide for physical delivery of a particular commodity or item and those which call for a cash settlement. The month during which delivery or settlement is to occur is specified. Thus, a July futures contract is one providing for delivery or settlement in July. In contrast, cash settlement futures contracts are precisely that, contracts which are settled in cash rather than by delivery at the time the contract expires. Stock index futures contracts, for example, are settled in cash on the basis of the index number at the close of the final day of trading. There is no provision for delivery of the shares of stock that make up the various indexes. Trading has also been initiated in options on futures contracts, enabling option buyers to participate in futures markets with known risks.

Swaps allow entities to exchange either variable cash flows for fixed payments, fixed cash flows for fixed payments, or variable cash flows for variable payments. They are similar to options but no premium (i.e., up-front money) is paid to obtain the rights. It is essentially an outright trade based on the expected movement of the price of the derivative's underlying commodity.

Options on futures contracts have added a new dimension to futures trading. Present-day options trading on the floor of an exchange began in April 1973 when the Chicago Board of Trade created the Chicago Board Options Exchange (CBOE) for the sole purpose of trading options on a limited number of New York Stock Exchange-listed equities. Options on futures contracts were introduced at the CBOT in October 1982 when the exchange began trading Options on U.S. Treasury Bond futures. An option, when purchased, gives the buyer the right (but not the obligation) to buy or sell a specific amount of a specific commodity at a specific price within a specific period of time. By comparison, a futures contract requires a buyer or seller to perform under the terms of the contract if an open position is not offset before expiration. Put and call options on futures contracts make it possible to speculate on increasing or decreasing futures prices with a known and limited risk. The most that the buyer of an option can lose is the cost of purchasing the option (known as the option “premium”) plus transaction costs.

The buyer of a call option acquires the right but not the obligation to purchase (“go long”) a particular futures contract at a specified price at any time during the life of the option. Each option specifies the futures contract which may be purchased (known as the “underlying” futures contract) and the price at which it can be purchased (known as the “exercise” or “strike” price). The most that an option buyer can lose is the option premium plus transaction costs. This will be the case if an option held until expiration is not worthwhile to exercise.

Whereas a call option conveys the right to purchase (“go long”) a particular futures contract at a specified price, a put option conveys the right to sell (“go short”) a particular futures contract at a specified price. Put options can be purchased to profit from an anticipated price decrease. As in the case of call options, the most that a put option buyer can lose, if he is wrong about the direction or timing of the price change, is the option premium plus transaction costs.

How Option Premiums are Determined

Option premiums are determined the same way futures prices are determined, through active competition between buyers and sellers. Three major variables influence the premium for a given option:
The option's exercise price, or more specifically, the relationship between the exercise price and the current price of the underlying futures contract, index, etc. All else being equal, an option that already has intrinsic value because it is already worthwhile to exercise (known as an “in-the-money” option, where the underlying value is greater than the strike value for a call, or where the underlying value is less than the strike value for a put) commands a higher premium than an option that is not yet worthwhile to exercise (an “out-of-the-money” option, where the underlying value is less than the strike value for a call, or where the underlying value is greater than the strike value for a put). The more an option is in-the-money, the more it is worth
The length of time remaining until expiration. All else being equal, an option with a long period of time remaining until expiration commands a higher premium than an option with a short period of time remaining until expiration because it has more time in which to become profitable. Said another way, an option is an eroding asset. Its time value declines as it approaches expiration.
The volatility of the underlying futures contract. All else being equal, the greater the volatility the higher the option premium. In a volatile market, the option stands a greater chance of becoming profitable to exercise; thus, buyers pay more while writers demand higher premiums.

The price (value) of an option premium on a futures contract is determined competitively by open outcry auction on a trading floor (e.g. CBOT, NYME). The premium is affected by the influx of buy and sell orders reaching the exchange floor. An option buyer pays the premium in cash to the option seller. This cash payment is credited to the seller's account. Such price determination may just as easily occur on an electronic platform which processes incoming buy and sell orders, and it is the intention of many exchanges to migrate to this newer method of conducting trading operations.

Price Movements

Once a closing bell signals the end of a day's trading, the exchange's clearing organization matches each purchase made that day with its corresponding sale and tallies each member firm's gains or losses based on that day's price changes—a massive undertaking considering that nearly two-thirds of a million futures contracts are bought and sold on an average day. Each firm, in turn, calculates the gains and losses for each of its customers having futures contracts.

Gains and losses on futures contracts are not only calculated on a daily basis, they are credited and deducted on a daily basis. Thus, if a speculator were to have, say, a $300 profit as a result of the day's price changes, that amount would be immediately credited to his brokerage account and, unless required for other purposes, could be withdrawn. On the other hand, if the day's price changes had resulted in a $300 loss, his account would be immediately debited for that amount. This process is known as a daily cash settlement and is an important feature of futures trading. Because of margin requirements, it is the reason a party which incurs a loss on a futures position may be called on to deposit additional funds to its account.

The leverage of futures trading stems from the fact that only a relatively small amount of money (known as initial margin) is required to buy or sell a futures contract. On a particular day, a margin deposit of only $1,000 might enable an investor to buy or sell a futures contract covering $25,000 worth of soybeans. Or for $10,000, the investor might be able to purchase a futures contract covering common stocks worth $260,000. The smaller the margin in relation to the value of the futures contract, the greater the leverage. Leverage can produce either large profits in relation to initial margin, or large losses, depending on which way the price on the underlying futures contract changes. In this respect, leverage is a two-edged sword. For example, assume that in anticipation of rising stock prices an investor buys one June S&P 500 stock index futures contract at a time when the June index is trading at 1000 (assuming an initial margin requirement of $10,000). Since the value of the futures contract is $250 times the index, each 1 point change in the index represents a $250 gain or loss. Thus, an increase in the index from 1000 to 1040 would double the $10,000 margin deposit and a decrease from 1000 to 960 would wipe it out. In this example, that's a 100% gain or loss as the result of only a 4% change in the stock index Leverage will have a similar impact on real estate index linked futures contracts.

Real estate index linked futures contacts will have both initial margin and maintenance margin. Initial margin (sometimes called original margin) is the sum of money that the customer must deposit with the brokerage firm for each futures contract to be bought or sold. Profits will accrue on open positions and losses will be deducted from the balance in the margin account. If and when the funds remaining available in the margin account are reduced by losses to below a certain level—known as the maintenance margin requirement—an additional deposit of funds will be required to bring the account back to the level of the initial margin. Such requests for additional margin are known as margin calls.

Derivatives are typically used by institutional investors to increase overall portfolio return or to manage portfolio risks. Derivatives are also frequently used by banks, companies, organizations, and the like to protect against market risks in general. For example, utility companies may be interested in protecting against meeting heating or cooling demands when unexpected weather occurs, and banks may be interested in protecting against the risk of loan defaults. Derivatives help in managing risks by allowing such banks, companies, organizations, and the like to divide their risk into several pieces that may be passed off to other entities that are willing to shoulder the risk for an up-front fee or future payment stream.

Derivatives, being a type of financial instrument, may be traded among investors as are stocks, bonds, and the like. Thus, in order to trade derivatives, there must be a mechanism to price them so that traders may exchange them in an open market.

The relationship between the value of a derivative and the underlying asset are not linear and can be very complex. Economists have developed pricing models to perform valuation of certain types of derivatives. As is well known in the relevant art(s), the Black-Scholes option pricing model is the most influential and extensively used pricing model. The Black-Scholes model is based on stochastic calculus and is described in detail in a variety of publicly available documents, such as Chriss, Neil A., The Black-Scholes and Beyond Interactive Toolkit: A Step-by-Step Guide to In-depth Option Pricing Models, McGraw-Hill, 1997, ISBN: 078631026X (USA), which is incorporated herein by reference in its entirety.

Whether using the Black-Scholes or any other pricing model, each has inherent flaws and thus poses risks. It has been estimated that some 40% of losses in dealing with derivatives can be traced to problems related to pricing models. Risks in relying on any model include errors in the model's underlying assumptions, errors in calculation when using the model, and failure to account for variables (i.e., occurrences) that may affect the underlying assets.

Real estate indices, and more specifically future expected movement in such indices, have not yet been an area of application for pricing models. The few models that have considered real estate prices usually have only considered past (i.e., historical) real estate price or index data. That is, most models assume, for example, that real estate prices are cyclical in nature. Historical analysis has shown, however, that this assumption does not always hold true. Thus, regardless of the index or instrument, risk management trading techniques or vehicles, traders essentially have been operating in the “blind” without knowledge of real estate predicted future index movements.

### SUMMARY OF THE INVENTION

The present invention is a system, method, and computer program product for the creation, identification, processing, trading, quotation, and valuation of real estate index linked financial instruments and/or financial instruments that are impacted in some manner by real estate indices. The method preferably involves specifying a start date and maturity date for the financial instrument, and selecting at least one geographic region to be covered by the financial instrument, and at least one currency denomination in which to represent the financial instrument. Then, at least one real estate index that the financial instrument will derive its value from or is related to (or impacted by) is selected. The index to be used could be from (but is not limited to) one of the following index compilations cited here as examples, and which are incorporated herein by reference in their entirety:
Freddie Mac Conventional Mortgage Home Price Index: MSA (Metropolitan Statistical Area) Series
Office of Management and Budget Metropolitan and Micropolitan Statistical Areas and Principal Cities (Source: Population Division, U.S. Census Bureau)
Japan Real Estate Institute (JREI) Indices
Office of Federal Housing Enterprise Oversight (OFHEO) House Price Index and other reports
National Property Index (NPI) published by National Council for Real Estate Investment Fiduciaries (NCRIEF)
Netherlands: ROZ/IPD property index
UK IPD
F&T Price Indices of Real Estate in Some Large and Medium Cities in China in 1 Q/2003
F&T Movement Indices for Chinese cities, including but not limited to: Shenzhen, Chendu, Chongqin, Tianjin, Beijing and Shanghai.
National Association of Realtors' Real Estate Outlook (published monthly)
Department of Housing and Urban Development: U.S. Housing Market Conditions
Urban Redevelopment Authority of Singapore: Price & Rental Indices

Other sources for real estate index information include, but are not limited to: European Mortgage Federation, International Union for Housing Finance, Bulwien, ESRI, Ministerio de Fomento, Nationwide Building Society, Nomisma, Stadium, BIS, Credit Suisse First Boston, HSBC, UBS, ABS, Jones Lang Lasalle, Investment Property Databank, and Deutsche Bank.

Indices that may be selected may even apply to a subset of a regional market. For example, F&T supplies the following index publications upon which real estate index linked financial instruments may be created for the purposes of speculation upon a particular market segment within a geography:
F&T Supply and Demand Area of Newly Marketed Non-residential Projects in Jan.-Mar. 2003 in Fuzhou
F&T Comparison of Quantitative Indices of Luxurious Houses in Shenzhen and Hong Kong
F&T Major Indices of Office Buildings in Beijing Financial Street in 2002-Mar. 2003

Finally, property indices published by private firms may be considered as a basis for real estate index linked financial instruments. An example would be the CB Richard Ellis series, such as CB Richard Ellis Global Market Rents report.

Additionally, International Commercial Property Associates has maintained a database of commercial rents and yields for a number of countries around the world. The rent data is gathered by Hillier-Parker in the U.K. and affiliates in Southeast Asia and Australia and Landauer in the U.S. Other real estate research firms report information to ICPA for rents in Europe, Canada and Scandinavia. These data, despite certain limitations, provide a fascinating glimpse of the world real estate crash over the late 1980s and late 1990s.

Because of the particular characteristics of real estate, representing real estate markets through a reliable time-series is a complex task. Consequently, reliable real estate indices with a sufficiently long history in major international real estate markets are only scarcely available. Most of the research that has been done on real estate returns was done for the U.K. and U.S., where eligible indices exist. On the other hand, in other important real estate markets, such as Germany, either little or no research has been performed.

The advantage of the present invention is that it can easily be implemented from existing financial infrastructure. The present invention makes use of real estate indices, financial instruments such as options, and pricing models to create a new class of financial instruments that are priced based on linkages to underlying real estate index data. Much as options exist on the Standard & Poor's 500 index, real estate index linked financial instruments allow buyers and sellers to speculate upon the movement of broad swaths of the global real estate market. Real estate index linked financial instruments call for cash settlement rather than delivery of the underlying physical stock, commodity, or other asset type upon which derivative financial instruments may be based. Delivery-type futures contracts, for example, stipulate the specifications of the commodity to be delivered (such as 5,000 bushels of grain, 40,000 pounds of livestock, or 100 troy ounces of gold). Also, foreign currency futures provide for delivery of a specified number of euros, yen, pounds or pesos. U.S. Treasury obligation futures are in terms of instruments having a stated face value (such as $100,000 or $1 million) at maturity. In contrast, for example, derivative financial instruments which call for cash settlement rather than delivery are based on a given index number times a specified dollar multiple. This is the case, for example, with stock index futures—and is also be the case with the present invention since real estate index linked financial instruments are linked by their very definition to underlying indices. One possible mechanism for facilitating this form of settlement would be cashless exercise. Cashless exercise is a transaction used when exercising certain types of options. Essentially, the investor borrows enough money from his/her broker to exercise the options. The investor then simultaneously sells enough shares to pay for the purchase, taxes, and broker commissions. The investor is technically buying on margin. The brokerage lets the investor buy on margin in this case because the brokerage knows there will be a quick repayment. The advantage of this technique is that the investor does not need the cash on hand.

The present invention includes a systemic component that processes real estate index information according to inputs. In the preferred embodiment of the present invention, a financial database may be accessed so that an interest rate or rates can be specified for use in pricing a financial instrument based upon an underlying real estate index. A real estate index history database and a real estate predicted future index database are then accessed to obtain historic real estate index information and the real estate predicted future index information for the geographic location during the period between the start date and the maturity date. A pricing model can then be applied to obtain a value for the real estate index linked financial instrument using the historical real estate index information, the real estate predicted future index information, and the risk-free rate.

The system for the valuation of a real estate index linked financial instrument of the present invention includes a real estate index history database that stores historical real estate index information for one or more indices, and/or a real estate predicted future index database that stores real estate predicted future index information for the one or more indices. The system may also include a financial database that stores information in order to calculate a risk-free rate. In order to access the databases and perform valuation of financial instruments, a trading server is included within the system. The trading server provides the central processing of the system by applying a pricing model, and is responsive to a plurality of internal and external workstations that allow users, via a graphical user interface, to access the trading system.

One advantage of the present invention is that the futures, options, swaps, and other derivative financial instruments which comprise the present invention can allow investors to trade on information related to how real estate prices will trend in geographic areas such as localities, cities, regions, states, nations, or multinational/international areas. In the preferred embodiment of the present invention, real estate index linked financial instruments will call for a cash settlement rather than physical delivery, as physical delivery is not possible in the case of financial instruments that are linked to underlying indices instead of physical commodities (such as oil or stock). As previously mentioned, one possible mechanism for facilitating this form of settlement would be cashless exercise. It is also a preferred embodiment of the present invention that buyers and sellers of real estate index linked financial instruments may place their orders through a brokerage agent or trader to facilitate execution on a physical or electronic exchange.

Another advantage of the present invention is that information and data sets can be provided that enable traders to identify and capitalize on real estate index-driven market fluctuations.

Further features and advantages of the invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram representing the system architecture of an embodiment of the present invention;

FIG. 2 depicts a preferred real estate index history database which may be used by the present invention;

FIG. 3 depicts a preferred real estate predicted future index database which may be used by the present invention;

FIG. 4 is a flowchart representing the preferred operation of the present invention;

FIG. 5 is an exemplary graphical user interface screen for the trading system of the present invention; and

FIG. 6 is a block diagram of an exemplary computer system useful for implementing the present invention.

### DETAILED DESCRIPTION OF THE PREFERRED EMBODIMENTS

A. Overview of Real Estate Index Linked Financial Instruments

1. How Real Estate Index Linked Financial Instruments Are Created And Used

Recently, with speculation on potentially overpriced real estate in America, Britain and Australia, the need for a new type of financial instrument has become evident-a real estate index-linked financial instrument. The present invention allows the creation, identification, processing, trading, quotation, and valuation of a new type of financial instrument which is a real estate index linked financial instrument. A real estate index linked financial instrument is a contract whose value is based on the fluctuations in indices for real estate prices on the local, city, regional, state, national, or multinational/international level. Real estate index linked financial instruments may be utilized, by way of example but not limited to, REITs (real estate investment trusts) which may want to buy put options based on a real estate index in order to manage the risk of a collapse in real estate prices in a city or state where the REIT owns real estate. Settlement of such contracts may involve initial margin/good faith deposits to allow buyers to employ leverage at the time of purchase and thus put down less cash than the face value of the contract at the time of purchase. The settlement transactions could take place based on each day's closing price of the instrument in question.

A real estate index linked futures contract (a subset of real estate index linked financial instruments) is designed to trade either on an exchange or system (either open-outcry or electronic), an ECN (electronic commerce system), an over-the-counter system (OTC). The terms and definition of this futures contract are similar to that of existing futures contracts, but are not necessarily limited in scope to those existing instruments. Forward and futures contracts are standardized, transferable agreements, which may be exchange-traded, to buy or sell a commodity (e.g. a particular crop, livestock, oil, gas, etc.). These contracts typically involve an agreed-upon place and time in the future between two parties.

Real estate index linked options contracts are also a subset of real estate index linked financial instruments. Typically, options contracts are agreements that may be exchange-traded among two parties. Options represent the right to buy or sell a specified amount of an underlying security (e.g. a stock, bond, futures contract, etc.) at a specified price within a specified time. The parties of options contracts are purchasers who acquire “rights,” and sellers who assume “obligations.” Further, a “call” option contract is one giving the owner the right to buy, whereas a “put” option contract is one giving the owner the right to sell the underlying security. There is typically an up-front, non-refundable premium that the buyer pays the seller to obtain the option rights. With regards to a real estate index linked options contract, there is no underlying security, but rather an underlying index value tied to real estate price performance in a particular municipality, micropolitan area, metropolitan area, state or province, nation, or multi-nation region.

The pricing of an option of an asset is a fundamental problem of significant practical importance in today's financial markets. In 1973, a mathematician, Fischer Black, and an economist, Myron Scholes, devised one of the first mathematically accepted approaches for pricing what is known as a “European” option, which are options that can only be exercised at its expiration date. What has become known as the Black-Scholes option formula was described first in “The pricing of options and corporate liabilities,” Journal of Political Economy 81 (1973), which is incorporated herein by reference in its entirety. The Black-Scholes option formula is presently of widespread use in financial markets all over the world. The price of such an option can be found by solving the Black-Scholes equation with the initial condition at expiration (i.e., the payoff of the option). The Black-Scholes equation is a reverse diffusion equation with parameters determined by the statistical characteristics of involved stocks and currencies such as risk free interest rate, holding cost or expected dividends, and volatility.

As an example, the Black-Scholes formula for the theoretical price of a vanilla European call option is:
C=S*N(d₁)−Ke^{-(rt)}*N(d₂) (1)
where the notation is fairly standard, as described by P. Wilmott, J. N. Dewynne and S. Howison, “Option Pricing: Mathematical Models and Computation”, Oxford Financial Press, Oxford (1993).

However, in the case of American options, the above formula (1) and its analogs are no longer valid. In fact, as shown in P. Jaillet, D. Lamberton, and B. Lapeyre, “Variational inequalities and the pricing of American options,” Acta Applicandae Mathematicae 21 (1990) 263-289, a rigorous mathematical model for pricing an American option is an infinite-dimensional free boundary problem, which is incorporated herein by reference in its entirety. As such, there is in general no explicit formula or finite procedure for computing the exact price of an American option. As a result, various mathematical models have been devised in an attempt to approximate the price of such options.

The option prices computed from a mathematical model are of a theoretical nature. In computing these prices, various inputs are fed into the model and an algorithm produces an answer. In practice, the computed prices may not be consistent with the observed market prices, e.g., the prices on the trading floor. Ideally, these two sets of prices should coincide. However, such a result is difficult, if not impossible, using known models. Two principal reasons for this are: (i) the assumptions that lead to the construction of the mathematical model may not be realistic; and (ii) the inputs to the model are not correct. In particular, using an incorrect volatility parameter in the forward option pricing model means that the computed option price is bound to deviate, often substantially, from the option price observed on the trading exchange, either physical or electronic.

Previous approaches for dealing with this difficult problem of unknown volatility are numerous and include: (i) statistical estimation methods based on historical data (such as J. Hull, Options, Futures, and Other Derivative Securities, Second Edition, Prentice Hall, New Jersey (1989), Section 10.4 and R. Gibson, Option Valuation: Analyzing and Pricing Standardized Option Contracts, McGraw-Hill, New York (1991), Section 1; (ii) mathematical models of stochastic volatilities such as those in J. Hull and A. White, “The pricing of options on assets with stochastic volatilities,” The Journal of Finance 42 (1987) 281-300; H. Johnson and D. Shanno, “Option pricing when the variance is changing,” Journal of Financial and Quantitative Analysis 22 (1987) 143-151; and (iii) implied volatilities based on observed option prices (suggested originally by H. A. Latant and R. J. Rendleman, “Standard deviations of stock price ratios implied in option prices,” The Journal of Finance 31 (1976) 369-381 and empirically tested by S. Beckers, “Standard deviation implied in option prices as predictors of future stock price volatility” Journal of Banking and Finance 5 (1981) 363-381). All of these works are incorporated herein by reference in their entirety.

Options on Real Estate Index Linked Futures Contracts

These are options that will have their value determined by the dependence on an underlying real estate index linked futures contract.

Real Estate Index Linked Call Option on Futures Contract: This call option on a futures contract is an option where the purchaser has the right, but not the obligation, to buy the underlying security from the writer/seller of the option during a defined period of time at a fixed price wherein the underlying security is a real estate index linked futures contract. Settlement could require the exchange of the entire transaction value between the buyer and writer/seller, or exchange of the prevailing market price for the underlying security less the strike “price” or index value of the option.

Real Estate Index Linked Put Option on Futures Contract: This put option on a futures contract is an option where the purchaser has the right, but not the obligation, to sell the underlying security to the writer/seller of the option during a defined period of time at a fixed price wherein the underlying security is a real estate index linked futures contract. Settlement could require the exchange of the entire transaction value between the buyer and writer/seller, or exchange of the strike price or index value of the option less the prevailing market price for the underlying security.

Real Estate Index Linked Options

Real Estate Index Linked American Option: An option that can be exercised anytime during its life. The majority of exchange-traded options are American style. The name has nothing to do with geographic location.

Real Estate Index Linked Asian Option: An option whose payoff depends on the average price of the underlying asset over a certain period of time. These types of option contracts are attractive because they tend to cost less than regular American options. Also known as an ‘average option’.

Real Estate Index Linked Asset-or-Nothing Call Option: An option payoff that is equal to the asset's price if the asset is above the strike price, otherwise the payoff is zero.

Real Estate Index Linked Asset-or-Nothing Put Option: An option payoff that is equal to the asset's price if the asset is below the strike price, otherwise the payoff is zero.

Real Estate Index Linked Average Price Call: A type of option where the payoff is either zero or the amount by which the average real estate index linked value exceeds the strike.

Real Estate Index Linked Average Price Put: A type of option where the payoff is either zero or the amount by which the strike price exceeds the average real estate index linked value.

Real Estate Index Linked Balloon Option: An option for which the notional payments increase significantly after a set threshold is broken. Commonly used in foreign exchange markets, these options provide for greater leverage to the holder. The main idea behind the balloon option is that after the threshold is exceeded, the regular payout is increased. For example, assume that the threshold is $100. After the underlying exceeds this amount, rather than paying the regular dollar-for-dollar amount, the option payment would balloon to two dollars for every one-dollar change against the strike price.

Real Estate Index Linked Barrier Option: A type of option where the payoff depends on whether or not the underlying asset has reached or exceeded a predetermined price. A barrier option is a type of exotic option. Barrier options can be either knock-ins or knock-outs.

Real Estate Index Linked Basket Option: A type of option where the underlying value is a basket of real estate indices. This allows the buyer/holder to speculate upon a group of real estate indices with various weightings in the basket. For example, a buyer could purchase a real estate index linked basket option from a seller that is weighted accordingly: 30% to a real estate index derived from real estate prices in New York City, 30% to a real estate index derived from real estate prices in London, 20% to a real estate index derived from real estate prices across Japan as a whole, 10% to a real estate index derived from real estate prices across both the United Kingdom and Ireland, 5% to a real estate index derived from real estate prices across the state of California, and 5% to a real estate index derived from real estate prices in Toledo, Ohio. As will be apparent to those skilled in the art, real estate index linked basket options may be constructed across millions of permutations involving the selection of:

1.) a different index, indices or types of indices

2.) different weightings per index, indices or type of index

3.) different pay-in and/or payout currencies per weighting per index, indices, or type of index

4.) different triggers that may affect weightings at points in time for each index, indices, or types of indices

5.) differing option specifications and/or types per index, indices, or types of indices. For example, a real estate index linked basket option could be created with a call-type option (American exercise) on a 50% weighting in a New York City real estate index, a put-type option (Bermuda exercise) on a 30% weighting in a State of New Jersey real estate index, and a chooser-type option on a 20% weighting in a United States real estate index.

6.) different swaps and/or swap “legs” linked to each index, indices or types of indices comprising a real estate index linked basket option

7.) different swaptions linked to each index, indices, or types of indices comprising a real estate index linked basket option

8.) different commodities linked to each index, indices, or types of indices comprising a real estate index linked basket option

9.) different forwards linked to each index, indices, or types of indices comprising a real estate index linked basket option

10.) different futures linked to each index, indices, or types of indices comprising a real estate index linked basket option

11.) different caps linked to each index, indices, or types of indices comprising a real estate index linked basket option

12.) different floors linked to each index, indices, or types of indices comprising a real estate index linked basket option

13.) different collars linked to each index, indices, or types of indices comprising a real estate index linked basket option

14.) different corridors linked to each index, indices, or types of indices comprising a real estate index linked basket option

15.) different real estate index linked notes linked to each index, indices, or types of indices comprising a real estate index linked basket option

16.) different financial guarantees linked to each index, indices, or types of indices comprising a real estate index linked basket option

17.) different fixed-income instruments linked to each index, indices, or types of indices comprising a real estate index linked basket option

18.) different fixed-income indices linked to each index, indices, or types of indices comprising a real estate index linked basket option

19.) different equities linked to each index, indices, or types of indices comprising a real estate index linked basket option

20.) different equity indices linked to each index, indices, or types of indices comprising a real estate index linked basket option

21.) different commodity indices linked to each index, indices, or types of indices comprising a real estate index linked basket option

22.) different futures indices linked to each index, indices, or types of indices comprising a real estate index linked basket option

23.) different forwards indices linked to each index, indices, or types of indices comprising a real estate index linked basket option

24.) different swap indices linked to each index, indices, or types of indices comprising a real estate index linked basket option

25.) different option indices linked to each index, indices, or types of indices comprising a real estate index linked basket option

As a result of the component of the present invention known as real estate index linked basket options, investors may now construct investment positions that can benefit almost any portfolio strategy involving a geographic real estate component. As will be apparent to those skilled in the relevant arts, the above example and detailed list of permutations should in no way be construed to limit the spirit and scope of the present invention, which allows a vast array of arbitrage possibilities for investors and speculators to explore with the creation of real estate index linked financial instruments.

Real Estate Index Linked Bermuda Option: A type of option that can only be exercised on predetermined dates, usually every month. “Bermudas” are a combination of American and European style options.

Real Estate Index Linked Call Option: A call option where the purchaser has the right, but not the obligation, to buy a value as a strike price in the underlying index from the writer/seller of the contract during a defined period of time at a fixed price, wherein the underlying index is a real estate index with numerical values published at regular time intervals. The buyer profits on a call when the underlying index increases in value above the purchased value or strike price of the option. A premium is paid by the investor/buyer/holder of the option to the writer/seller of the option for this right. Settlement could require the exchange of the entire transaction value between the buyer and writer/seller, or the exchange of the prevailing market index value of the underlying real estate index less the strike price or index value of the contract, times a cash multiple.

Real Estate Index Linked Capped Option: An option with a pre-established profit cap. A capped option is automatically exercised when the underlying security closes at or above (for a call) or at or below (for a put) the option's cap price. This can also be referred to as a capped-style option.

Real Estate Index Linked Cash-or-Nothing Call: A type of option whose payoff is set to a specified fixed price if the final asset price is above the strike price; if not, the payoff is set to zero.

Real Estate Index Linked Cash-or-Nothing Put: A type of option whose payoff is set to a specified fixed price if the final asset price is below the strike price; if not, the payoff is set to zero.

Real Estate Index Linked Chameleon Option: An option that has the ability to change its structure, should certain pre-determined terms of the contract be met. An example of a chameleon option would be a put option that automatically changes into an identical call option after the price of the underlying exceeds a certain price. This is similar to a long or short straddle except investors are not required to open two positions.

Real Estate Index Linked Chooser Option: An option where the investor has the opportunity to choose whether the option is a put or call at a certain point in time during the life of the option. Also known as ‘hermaphrodite option’ or ‘AC-DC option’.

Real Estate Index Linked Cliquet: An extended option that periodically settles and resets its strike price at the level of the underlying during the time of settlement. For example, a 3 year cliquet option with a strike of 1000 would expire worthless on the first year if the underlying was to be 900. This value would then be the new strike for the following year and should the underlying on settlement be 1200, the contract holder would receive a payout and the strike would reset to this new level. Higher volatility provides better conditions for investors to earn profits. Also known as a ‘ratchet option’ or ‘cliquet option’.

Real Estate Index Linked Compound Option: An option on an option. Examples include a call on a call, a put on a put, a call on a put, and a put on a call. This type of option usually exists for currency or fixed income markets where an uncertainty exists regarding the option's risk protection capabilities. Also known as a split-fee option.

Real Estate Index Linked Contingent Option: An option for which the holder only pays the premium if the option is exercised. Contingent options are, therefore, a zero-cost option strategy, unless exercised.

Real Estate Index Linked Digital Option: An option whose payout is fixed after the underlying stock exceeds the predetermined threshold or strike price. The value of the payout is determined at the onset of the contract and doesn't depend on the magnitude by which the underlying index's price moves. So, should the investor be in the money by $1 or $5, the amount that the investor will receive will be the same. These options are also referred to as binary or all-or-nothing options.

Real Estate Index Linked Double Barrier Option: An option with two distinct triggers that define the allowable range for the price fluctuation of the underlying asset. In order for the investor to receive a payout, one of two situations must occur; the price must reach the range limits (for a knock-in) or the price must avoid touching either limit (for a knock-out). A double barrier option is a combination of two dependent knock-in or knock-out options. If one of the barriers is reached in a double knock-out option, the option is killed. If one of the barriers is reached in a double knock-in option, the option comes alive.

Real Estate Index Linked Double No-Touch Option: An option with two distinct triggers that define the allowable range for the price fluctuation of the underlying asset. The double no-touch option pays a fixed amount if the spot price never touches either of the two specified limits (barrier levels). Factors that must be specified are the desired payoff, the currency pair, the barrier price, and the expiration date. As long as the spot level never hits the two barrier levels, the buyer/holder receives the payoff amount at expiry. If the barrier is reached during the option period, the option expires worthless. An example of a double no-touch option is the following:

| Currency: | USD/JPY |
|---|---|
| Barrier Price #1: | 116 |
| Barrier Price #2: | 124 |
| Current Spot Level: | |
| Expiration Date: | 2 months from today |
| Payoff: | $7,000 |
| Cost: | $1,500 |
| Net profit if barrier is reached: | $5,500 |

If the spot value never reaches either barrier prior to expiry, then this option is profitable for the buyer. If the spot value reaches either barrier prior to expiry, then there is no payoff at expiry, and therefore this option is unprofitable for the buyer.

Real Estate Index Linked Down-and-In Option: An option that comes into existence when the price of an underlying security sinks to a specified level.

Real Estate Index Linked Down-and-Out Option: An option that ceases to exist when the price of an underlying security sinks to a specified level.

Real Estate Index Linked Embedded Option: An option that is an inseparable part of another instrument. Compare this to a normal (or bare) option, which trades separately from the underlying security. A common embedded option is the call provision in many corporate bonds.

Real Estate Index Linked Employee Stock Option: Stock options granted to specified employees of a company. ESOs carry the right, but not the obligation, to buy a certain amount of shares in the company at a predetermined price. ESOs are slightly different from regular options, because they do not have puts and the holder typically must wait a specified period before he/she/it is allowed to exercise the option. An Employee Stock Ownership Plan (ESOP) is an organized plan for the employees of a company to buy shares of its stock (also known as a stock purchase plan).

Real Estate Index Linked Foreign Exchange Option (ELF-X): A put or call option that protects an investor from foreign exchange risk for a future sale or purchase of a specified foreign equity portfolio. ELF-X options are a combination of a currency option and an equity forward contract. Should the exchange rate work in the investor's favor under the option contract, the total payout received from the option is dependent upon the performance of the equities underlying the contract. Otherwise, the investor does not receive a payout. For example, if an investor holds an ELF-X call option on USD relative to CAD, and the Canadian dollar depreciates relative to the American, the investor would not receive a payout. However, if USD depreciated relative to CAD, the investor would receive the amount saved from use of the spot exchange rate in the option contract and the foreign equity portfolio value, less the premium paid for the call option. Also known as a “portfolio currency protection option” or PCPO.

Real Estate Index Linked European Option: An option that can only be exercised at the end of its life. In other words, the holder must wait until the maturity date to exercise.

Real Estate Index Linked Evergreen Option: An employee option plan that grants additional shares to the plan every year. The number of shares granted to the plan is determined by a set percentage of the company's common shares outstanding. In most cases, these plans don't have an expiry date and do not require shareholder approval. Also known as an evergreen plan.

Real Estate Index Linked Exotic Option: Any non-standard option. This is the opposite of a “plain vanilla option.”

Real Estate Index Linked Flexible Exchange Option (FLEX): An option, generally written by clearing houses, that can be modified regarding expiration dates, strike prices, or exercising styles. Flex options provide flexibility to investors, as they can be tailored to meet their specific needs.

Real Estate Index Linked Incentive Stock Option (ISO): A type of employee stock option with a tax benefit, when the holder exercises, of not having to pay ordinary income tax. Instead, the options are taxed at a capital gains rate. Although ISOs have more favorable tax treatment than NSOs, they also require the holder to take on more risk by having to hold onto the stock for a longer period of time in order to receive the better tax treatment. Additionally, there are numerous restrictions which have to be met in order to qualify as an ISO.

Real Estate Index Linked Jump Option: An option which is priced using a jump-diffusion process.

Real Estate Index Linked Knock-in Option: An option which ‘knocks-in’ or begins to function as a normal option once a certain price level is reached before expiration. Knock-ins are a type of barrier option that may be either ‘down and in’ or ‘up and in.’

Real Estate Index Linked Knock-out Option: An option with a built in mechanism to expire worthless should a specified price level be exceeded.

Real Estate Index Linked Ladder Option or Note: An index or currency option or index-linked note that provides an upward reset of its minimum payout when the underlying touches or trades through certain steps or threshold levels or attains a certain level on designated reset dates. For example, if the underlying trades through a price 35 percent above the strike, the holder of the instrument may be guaranteed a minimum payout equal to the value of the instrument at that price even if the index subsequently declines. A series of steps can ratchet the minimum payout up the ladder, providing protection from a later decline in the index. Also called Lock-Step Option, Step-Lock Option or Note, Cliquet Option, or Ratchet Option. Related to Infinite Ladder Option and Shout Option.

Real Estate Index Linked Long Term Equity Anticipation Securities (LEAPS): An options contract that expires more than 9 months in advance, and can last as long as 2 years. Normal options tend to last no longer than nine months. LEAPS are an excellent way to make a long term option investment. LEAPS trade like normal options, but allow investors to benefit from the appreciation of equities while placing a lot less money at risk than is required to purchase stock.

Real Estate Index Linked Lookback Option: An exotic option that reduces uncertainties associated with the timing of market entry. There are two types of lookback options: fixed and floating.
Fixed—the option's strike price is fixed at purchase. However, the underlying is priced at its highest or lowest level, depending whether it is a call or put, during the life of the option rather than expiring at market.
Floating—the option's strike price is fixed at maturity. For a call the price is fixed at the lowest price during the life of the option, for a put it is fixed at the highest price. The option settles at market and against the floating strike.

Real Estate Index Linked Mid-Atlantic Option: An option that can be exercised at different times during the life of the option. The various times set for exercise are written within the option and allow for flexibility for both the writer and holder of the option. The Mid-Atlantic option is named as such because its exercise dates are more flexible than European options and less flexible than American options. Thus, it is in the middle, similar to the Atlantic Ocean being between Europe and America. Mid-Atlantic options are also referred to as Bermuda, Quasi-American, or Semi-American options.

Real Estate Index Linked Naked Call Option: An option where the writer of a call option does not own a long position in the stock on which the call has been written. Naked options are very risky. Profits are huge if the underlying asset moves in the direction desired by the buyer. On the other hand, a writer/seller of a naked call option can lose big if the underlying asset moves in the direction desired by the buyer. Sometimes referred to as an uncovered call.

Real Estate Index Linked Naked Option: An option position where the buyer or seller has no underlying security position. Naked options are very risky. Profits are huge if the underlying asset moves in the direction desired by the buyer. On the other hand, a writer/seller of a naked option can lose big if the underlying asset moves in the direction desired by the buyer.

Real Estate Index Linked Naked Put Option: An option where the writer of a put option does not have a short position in the stock on which the put has been written. Naked options are very risky. Profits are huge if the underlying asset moves in the direction desired by the buyer. On the other hand, a writer/seller of a naked put option can lose big if the underlying asset moves in the direction desired by the buyer. Sometimes referred to as an uncovered put.

Real Estate Index Linked Nonqualified Stock Options (NSO): A type of employee stock option where the holder pays ordinary income tax on the difference between the grant price and the price at which the holder exercises the option. NSOs are simpler and more common than ISOs. They're called non-qualified stock options because they don't meet all of the requirements of the Internal Revenue Code to be qualified as incentive stock options.

Real Estate Index Linked No-Touch Options: A no-touch option is a great way to profit from a trending market. The no-touch option pays a fixed amount if the market never touches the barrier level that the holder chooses. All the holder needs to do is to determine the desired payoff, the currency pair, the barrier price, and the expiration date. As long as the spot level never hits the barrier price before expiry, the holder receives the payoff amount. If the barrier is reached during the option period, the option expires worthless. An example of a no-touch option is the following:

| Currency: | EUR/USD |
|---|---|
| Barrier Price: | 1.0625 |
| Current Spot Level: | 1.0550 |
| Expiration Date: | 7 days from today |
| Payoff: | $3,000 |
| Cost: | $1,000 |
| Net profit if barrier is reached: | $2,000 |

If the spot value never reaches the relevant barrier prior to expiry, then this option is profitable for the buyer. If the spot price reaches the relevant barrier prior to expiry, then there is no payoff at expiry, and therefore this option is unprofitable for the buyer.

Real Estate Index Linked Option: A call or put option on a financial index. For example, options on the S&P 500 are some of the most actively traded options in the world. This type of option is a put or a call option based upon an underlying index. By way of example, the index could be, but is not limited to, a Metropolitan or Micropolitan Statistical Area index or other real estate index.

Real Estate Index Linked Option Chain: A way of quoting options prices through a list of all of the options for a given security. It includes the various strike prices, expiration dates, and whether they are calls or puts.

Real Estate Index Linked Partial Lookback Option: An option that provides a time window of, say, 30 to 90 days, during which the strike price is set or reset at the most favorable level during that period. After that period, the option is an ordinary American-style option. Because the lookback characteristic covers a limited time, the partial lookback option will sell for a price intermediate between a traditional option and a full lookback option. See also Lookback Currency Option, Lookback Strike Option, Reset Option, or Step-Down Option.

Real Estate Index Linked Path Dependant Option: An exotic option that is valued according to pre-determined price requirements for its underlying asset or commodity. The payoffs associated with these options are determined by the path of the underlying asset's price. Examples include Asian, Barrier and lookback options.

Real Estate Index Linked Put Option: A put option where the purchaser has the right, but not the obligation, to sell a value as a strike price in the underlying index to the writer/seller of the contract during a defined period of time at a fixed price, wherein the underlying index is a real estate index with numerical values published at regular time intervals. The buyer profits on a put when the underlying index decreases in value below the purchased value or strike price of the option. A premium is paid by the investor/buyer/holder of the option to the writer/seller of the option for this right. Settlement could require the exchange of the entire transaction value between the buyer and writer/seller, or exchange of the strike price or index value of the contract less the prevailing market index value of the underlying real estate index, times a cash multiple.

Real Estate Index Linked Quanto Option: An option in one country's currency that pays out in another country's currency. This is usually used when an investor believes that a stock will do well in another country, but fears that the country's currency will not. The investor buys an option in the foreign stock while keeping the payout in his or her home currency.

Real Estate Index Linked Rainbow Option: An option that is written on more than one underlying asset. Rainbow options are usually calls or puts on the best or worst of n underlying assets, or options which pay the best or worst of n assets. Rainbow options at exercise may deliver either the best or worse asset in the rainbow or a call or put option on the better or worse of the assets. “Multi-color” rainbow options could deliver the best or worst m of the n assets. Spread options are a special case of rainbow options.

Real Estate Index Linked Rebate Barrier Option: A barrier option that offers a predetermined rebate, should the option be ‘knocked-out.’ Should a rebate be enacted, it will be deducted from the premium paid to the issuer, thus reducing the issuer's potential profit. For this reason, it is uncommon to see a rebate opportunity attached to a barrier option.

Real Estate Index Linked Reload Option: An employee stock option that grants additional options upon exercise of the original. The employee satisfies the exercise price of their current option with shares rather than cash. The reload option will have the same expiry date as the original option; however, the strike price will be equal to the share price at the time the original option is exercised. Also known as a restoration option.

Real Estate Index Linked Russian Option: A lookback option without an expiry date. This type of option can have either an American or a Mid-Atlantic settlement. It is a perpetual lookback option.

Real Estate Index Linked Shout Options: An exotic option that allows the holder to lock in a defined profit while maintaining the right to continue participating in gains without a loss of locked in monies. Shout options can be structured so that holders of this contract have more than one opportunity to “shout” or lock in profits. This allows holders to continue to benefit from positive market movements without the possibility of losing already locked in profits due to unfavorable conditions.

Real Estate Index Linked Up-and-In Option: The name for an option that exists only when the price of its underlying asset has reached a pre-specified price level.

Real Estate Index Linked Up-and-Out Option: The name for an option that ceases to exist when the price of its underlying asset has reached a pre-specified price level.

Real Estate Index Linked Vanilla Option: A normal option with no special or unusual features. A “plain vanilla option” is a regular option, the opposite of which is an exotic option.

Real Estate Index Linked Wild Card Option: An option associated with treasury-bond or treasury-note futures contracts that permits the short position to delay the delivery of the underlying. This provision allows the short futures contract holder to announce his or her intention to deliver the underlying securities on any notice day before a specified time, which is later than the regular trading hours, in which invoice prices are normally fixed. The security that is delivered is usually the cheapest to deliver on that specific day.

Real Estate Index Linked Caps, Collars, Corridors, and Floors

Real Estate Index Linked Cap: An upper limit on the interest rate on a floating-rate note (FRN) or an adjustable-rate mortgage (ARM), or an upper limit on the value of a real estate index value linked to a real estate index linked financial instrument.

Real Estate Index Linked Collar: An upper and lower limit on the interest rate on a floating-rate note (FRN) or an adjustable-rate mortgage (ARM).

Real Estate Index Linked Corridor: A combination of a real estate index linked cap and a real estate index linked floor in order to create a “corridor” within which the floating value of the relevant real estate index (indices) linked instrument must remain within a specified period of time in order to become “in the money”.

Real Estate Index Linked Floor: A lower limit on the interest rate on a floating-rate note (FRN) or an adjustable-rate mortgage (ARM), or a lower limit on the value of a real estate index value linked to a real estate index linked financial instrument.

Real Estate Index Linked Notes

Real Estate Index Linked Note: Any debt security issued with either principal or interest payments being determined by or linked to a real estate index.

Real Estate Index Linked Forwards and Futures

Real Estate Index Linked Forward Contract: A cash market transaction in which delivery of the commodity is deferred until after the contract has been made. Although the delivery is made in the future, the price is determined at the initial trade date. Most forward contracts don't have standards and aren't traded on exchanges. A farmer would use a forward contract to “lock-in” a price for his grain for the upcoming fall harvest. Note that real estate index-linked financial instruments do not involve the actual delivery of a commodity, but instead involve settlement based upon the change in value between the spot and forward prices. Settlement could require the exchange of the entire transaction value between the buyer and writer/seller, or exchange of the prevailing market value for the underlying index less the strike “price” or value of the contract. Settlement could otherwise require the exchange of the entire transaction value between the buyer and writer/seller, or exchange of the strike “price” or value of the contract less the prevailing market value for the underlying index.

Real Estate Index Linked Forward Rate Agreement (FRA): A forward contract that determines an interest rate to be paid or received on an obligation beginning at a start date sometime in the future. Also referred to as a “Future Rate Agreement.” Any gain or loss on the agreement is like a gain or loss on an option or futures contract.

Real Estate Index Linked Futures Contract: An exchange traded agreement to buy or sell a particular type and grade of commodity for delivery at an agreed upon place and time in the future. Futures contracts are transferable between parties. Commodity futures very rarely lead to the delivery of a commodity because positions are usually closed out (“offset”) before the delivery date. In contrast, forward contracts often lead to delivery. Note that real estate index-linked financial instruments do not involve the actual delivery of a commodity, but instead involve settlement based upon the change in value between the spot and forward prices. Settlement could require the exchange of the entire transaction value between the buyer and writer/seller, or exchange of the prevailing market value for the underlying index less the strike “price” or value of the contract. Settlement could otherwise require the exchange of the entire transaction value between the buyer and writer/seller, or exchange of the strike “price” or value of the contract less the prevailing market value for the underlying index.

Real Estate Index Linked Managed Futures Account: A managed futures account which combines the different profiles of a variety of real estate index linked futures, forwards and options on futures into a composite account or fund. Currently, managed futures are like a mutual fund, except that positions in securities, futures contracts, and options on futures contracts are used to manage the portfolio. Also known as a Commodity Pool.

Real Estate Index Linked Swaptions

Real Estate Index Linked Swaption (Swap Option): The option to enter into an interest rate swap. In exchange for an option premium, the buyer gains the right, but not the obligation, to enter into a specified swap agreement with the issuer on a specified future date. The agreement will specify whether the buyer of the swaption will be a fixed-rate receiver (like a call option on a real estate index linked financial instrument) or a fixed-rate payer (like a put option on a real estate index linked financial instrument). In such an option on a swap agreement, at least one, if not both “legs”, of the swap transaction are dependent on a real estate index in determining either the coupon rate or the principal amount.

Real Estate Index Linked Bermuda Swaption: A swaption with predefined limitations on exercise. Similar to a Bermuda option, a Bermuda swaption can only be exercised at certain times during its life.

Real Estate Index Linked Call Swaption: A financial instrument which gives the buyer the right, but not the obligation, to enter into a swap as a fixed-rate payer. The writer of the swaption therefore becomes the fixed-rate receiver/floating-rate payer.

Real Estate Index Linked Put Swaption: A financial instrument which gives the buyer the right, but not the obligation, to enter into a swap as a floating-rate payer. The writer of the swaption therefore becomes the floating-rate receiver/fixed-rate payer.

Real Estate Index Linked Swaps

Swaps allow entities to exchange variable cash flows for fixed payments. They are similar to options but no premium (i.e., up-front money) is paid to obtain the rights. It is essentially an outright trade based on the expected movement of the price of the derivative's underlying commodity, asset or index.

Real Estate Index Linked Swap: A swap agreement where at least one, if not both “legs” of the swap transaction are dependent on a real estate index in determining either the interest rate, coupon rate, the principal amount, or other financial element impacting one or both parties.

Traditionally, swaps involved the exchange of one security for another to change the maturity (bonds), quality of issues (stocks or bonds), or because investment objectives had changed. Recently, swaps have grown to include currency swaps and interest rates swaps. The other “leg” of the swap may be dependent on, but not limited to, a fixed interest rate, floating interest rate, currency exchange rate, equity index (e.g. S&P 500), commodity, or futures contract. If firms in separate countries have comparative advantages on interest rates, then a swap could benefit both firms. For example, one firm may have a lower fixed interest rate, while another has access to a lower floating interest rate. These firms could swap to take advantage of the lower rates.

Real Estate Index Linked Commodity Swap: A swap where exchanged cash flows are dependent on the price of an underlying commodity. In this swap, the user of a commodity would secure a maximum price and agree to pay a financial institution this fixed price. Then in return, the user would get payments based on the market price for the commodity involved. On the other side, a producer wishes to fix his income and would agree to pay the market price to a financial institution, in return for receiving fixed payments for the commodity.

Real Estate Index Linked Interest Rate Swap: A deal between banks or companies where borrowers switch floating-rate loans for fixed rate loans (for example, in another country). These can be either the same or different currencies. The advantage to this is that one company may have access to lower fixed rates and another company may have access to lower floating rates, which leads to a trade.

Real Estate Index Linked Forward Swap: A swap agreement created through the synthesis of two different swaps, differing in duration, for the purpose of fulfilling the specific timeframe needs of an investor. Sometimes swaps don't perfectly match the needs of investors wishing to manage certain risks. For example, if an investor wants to offset risk for a five-year duration beginning one year from today, they can enter into both a one-year and six-year swap, creating the forward swap that meets the requirements for their portfolio. Also referred to as a Forward Start Swap, Delayed Start Swap and a Deferred Start Swap.

Real Estate Index Linked Index Amortizing Swap: A swap whereby the notional principal amount of the agreement is amortized according to the movement of an underlying rate. Index amortizing swaps could be based on LIBOR or mortgage interest rates. Also known as “indexed principal swap”.

Real Estate Index Linked Quanto Swap: A dual swap combining a currency and/or interest rate transaction (with payment rates or returns denominated in a currency different than the currency used to state the notional principal amount, although both rates are calculated against the base currency). The purpose behind a quanto swap is to minimize foreign exchange risk. This is done by fixing the exchange rate and interest rate at the same time. This is also referred to as a CRoss-Index Basis (CRIB) Swap, Cross-Rate Swap, CUrrency Protected Swap (CUPS), Diff or Difference Swap, Differential Swap, Interest Rate Index Swap, LIBOR Differential Swap.

Real Estate Index Linked Spreadlock: An agreement that fixes the spread between the forward price of an interest rate swap and its underlying government bond yield. The spreadlock allows a future user of an interest rate swap to take advantage of the current spread between the swap rate and the bond rate. This is achieved by transferring the current savings in basis points to a date in the future, when both parties will enter the interest rate swap.

Real Estate Index Linked Variance Swap: A type of volatility swap where the payout is linear to variance rather than volatility. Therefore, the payout will rise at a higher rate than volatility. Variance is the square of standard deviation. Because of this, the payout of a variance swap will be larger than that of a volatility swap, as these products are based upon variance rather than standard deviation.

Real Estate Index Linked Volatility Swap: A forward contract whose underlying is the volatility of a given product. This is a pure volatility instrument, allowing investors to speculate solely upon the movement of an index's or indices' volatility without the influence of price. Thus, just like investors trying to speculate on the prices of stocks, by using this instrument investors are able to speculate on how volatile the index or indices will be.

Additional Terms and Conditions Applicable To Real Estate Index Linked Financial Instruments

It is a feature of the present invention that each type of real estate index linked financial instrument bears a unique identification number. A second number may be assigned to each contract of a particular type of said real estate index linked financial instrument.

In one embodiment of the present invention, contracts of a real estate index linked financial instrument may be combined with each other to form more complex financial products. Contracts of real estate index linked financial instruments may also be combined with other financial securities or indices to form more complex financial products. The other financial securities or indices include, but are not limited to, commodity futures and forwards, other indices such as the S&P 500, foreign exchange rates, domestic and foreign interest rates, equity securities, equity-linked securities or derivatives, equity-linked indices, fixed-income securities, fixed-income-linked securities or derivatives, and fixed-income-linked indices, and fixed-income-linked indices. For example, one embodiment of the present invention involves real estate loans that currently do not meet federal regulatory requirements under FFIEC (Federal Financial Institutions Examination Council) compliance criteria for being repackaged as securities. With the present invention, those loans which currently fail FFIEC criteria for securitization may be combined with real estate index-linked financial instruments to change their characteristics and meet FFIEC compliance criteria for securitization and subsequent trading in financial markets.

It is also an embodiment of the present invention that additional terms may be added to the documented set of terms that correspond to a real estate index linked option, future or other security. Such additional terms may address subjects including but not limited to: risk premiums; financial guarantees and/or covenants; guarantees of compliance with rules, conditions, and disclosure as set forth by the SEC, FASB, OFAC, and other regulatory bodies with oversight of capital markets; conformance to pre-determined financial measures (including but not limited to a specified debt-to-equity ratio, a specified quick ratio or quick asset ratio, and/or a specified net worth); and compliance with legal requirements for: ethical conduct in the ordinary course of business; corporate governance; sound financial management to fulfill obligations for the relevant real estate index linked financial instrument; board structure; disclosure of financial condition; and conflicts of interest.

It is a further embodiment of the present invention that additional risk definitions and contingency plans may be added to the documented set of terms that correspond to a real estate index linked option, future or other security. The additional risk definitions and contingency plans may address subjects including but not limited to: potential counterparty risk, potential home market risk, potential currency risk, potential sovereign/provisional/territorial government risk, potential political risk, potential agency risk (government-chartered and/or non-governmental), potential trading and exchange risk, and/or potential syndicate risk.

It is a further embodiment of the present invention that financial guarantees may be “wrapped” or included in the terms of a real estate index linked financial instrument. Such guarantees as Letters of Credit (LOC) have a Beneficiary, Obligor, and Guarantor. A Beneficiary requests an LOC from an Obligor as a guarantee against credit exposure. The Obligor will obtain the LOC from a Guarantor in favor of the Beneficiary. LOCs may be drawn against based on contractual provisions. By way of example, financial guarantees include, but are not limited to, the following:

Asset Value Guarantee—Guarantee asset value at a specific time, such as in aircraft leasing.

Bid Bond—To secure an offer to perform a task at a specified price.

Bond Guarantee—The obligation of one person to repay a debt taken on by someone else, should that person default.

Capital Guarantee—Guarantee an agreed upon level of equity.

Certificate of Insurance—Evidence of the existence of an insurance policy issued by the issuer of the policy.

Comfort Letter—Letter guaranteeing payment of obligations.

Commercial Paper Guarantee—Short term obligations issued to investors with temporarily idle cash.

Credit Guarantees—Guarantees the repayment of debt by the obligor.

Equity Swap—Notational principal swap in which the cash flows on at least one leg of the swap are linked to the total return on a single stock, a stock index, or some combination thereof.

Evergreen Provision—Refers to a provision for automatic roll-over of the LOC unless very specific conditions are met. LOC amounts are reviewed and reset on (generally) an annual basis to reflect changes in underlying exposure.

Financial Guarantee Insurance—Insurance created to cover losses from specified financial transactions.

Funding—Agreement to provide funds to finance a project or debt on or before maturity.

Guarantee—Guarantee payment of and/or performance of obligations.

Guarantee Letter—Guarantees commitment that the Obligor will have working capital at all times to meet obligations.

Hell-or-High-Water Contract—A non-cancelable contract whereby the purchaser must make the specified payments to the seller, regardless of any difficulties they may encounter. Hell-or-high-water clauses bind the purchaser or lessee to the terms of the contract until the contract's expiration. Also known as a ‘promise to pay’ contract.

Indemnification—Guarantee to restore to the condition prior to the loss

Irrevocable Letter of Credit—Issued by a bank guaranteeing the payment of a customer's drafts up to the stated amount for a specified period that cannot be changed or terminated without the agreement of the beneficiary.

Irrevocable Standby Letter of Credit—Issued by a bank guaranteeing the payment of a customer's drafts up to the stated amount for a specified period for a particular event that cannot be changed or terminated without the agreement of the beneficiary.

Keepwell Agreement—Guarantee residual values, payments, obligations, net worth as agreed.

Lease/Rent Guarantee—Guarantee real property lease and rent payments.

Letter of Comfort (by Italian Law is a Guaranty)—Guarantee residual values, payments, obligations, net worth as agreed, under Italian law.

Letter of Credit—Issued by a bank guaranteeing the payment of a customer's drafts up to the stated amount for a specified period.

Loss Guarantees on Construction Loans—Agreement to share losses with the beneficiary.

Payment Obligations—Guarantee payment obligations of the obligor.

Performance Obligations—Guarantee performance of policy obligations.

Policyholder Obligations—Fulfillment of insurance contract and to maintain rating from Agency Standard and Poor's.

Standby Letter of Credit—Issued by a bank guaranteeing the payment of a customer's drafts up to the stated amount for a specified period for a particular event.

Surety—A formal pledge to secure against loss.

Tender Guarantee—Offer of money or goods in settlement of a prior debt or claim.

Trust Agreement—A trust agreement is made and entered into by the beneficiary, the grantor (obligor) and a bank (Guarantor). A trust account is created into which assets are deposited.

Other Guarantees—All other financial guarantees.

The information stated in a financial guarantee may include, but is not limited to: naming of Beneficiaries, Obligors, and Guarantors; contact information such as mailing address and phone numbers; notional drawdown amounts; credit ratings and impacts of credit upgrades or downgrades; currency or currencies of denomination; expiry/renewal date if relevant; compliance notes such as dates for regulatory disclosure of commercial commitments or marking and reporting losses for off-balance sheet obligations; the identification of associated collateral; and other information that affects the structure of a financial guarantee.

2. Real Estate Indices

Real Estate Index Linked financial instruments (such as real estate index linked options, real estate index linked futures, and other real estate index linked securities) utilize a real estate index (instead of a stock or bond price) as the underlying value upon which the financial instrument's value is computed. These real estate indices are published by sources mentioned previously in this document, and exist for localities, cities, regions, states, nations, or multinational/international areas. Within the United States, real estate index numbers are available for Metropolitan and Micropolitan Statistical Areas (MSAs). Although the present invention will be discussed with regards to the nomenclature employed within the United States, it should in no way be construed that the present invention is limited only to financial instruments based upon real estate indices published within the United States. In fact, as will be readily apparent to one skilled in the art(s), the present invention can easily be applied to utilize real estate index information published anywhere in the world, and real estate index linked financial instruments could easily be created and traded in capital markets anywhere in the world. The present invention may also be applied across existing metrics for classifying regions, such as, but not limited to, mailing codes, parishes, cantons, and other statistical forms of subdividing areas upon which real estate indices may be based.

Metropolitan Statistical Areas

The general concept of a metropolitan area (MA) is one of a large population nucleus, together with adjacent communities that have a high degree of economic and social integration with that nucleus.

Each MA must contain either a place with a minimum population of 50,000 or a Census Bureau-defined urbanized area and a total MA population of at least 100,000. A MA comprises one or more counties. A MA may also include one or more outlying counties that have close economic and social relationships with the central county. An outlying county must have a specified level of commuting to the central counties and also must meet certain standards regarding metropolitan character, such as population density, urban population, and population growth.

Primary Metropolitan Statistical Area (PMSA)

If an area that qualifies as an MA has more than one million persons, primary metropolitan statistical areas (PMSA) may be defined within it. PMSAs consist of a large urbanized county or cluster of counties that demonstrate very strong internal economic and social links, in addition to close ties to other portions of the larger area. When PMSAs are established, the larger area of which they are component parts is designated a consolidated metropolitan statistical area (CMSA).

Metropolitan Statistical Area (MSA)

Metropolitan statistical areas (MSAs) are relatively freestanding MAs and are not closely associated with other MAs. These areas typically are surrounded by nonmetropolitan counties.

The United States Office of Management and Budget (OMB) defines metropolitan and micropolitan statistical areas according to published standards that are applied to Census Bureau data. The general concept of a metropolitan or micropolitan statistical area is that of a core area containing a substantial population nucleus, together with adjacent communities having a high degree of economic and social integration with that core. Currently defined metropolitan and micropolitan statistical areas are based on application of 2000 standards (which appeared in the Federal Register on Dec. 27, 2000) to 2000 decennial census data. Current metropolitan and micropolitan statistical area definitions were announced by OMB effective Jun. 6, 2003.

Standard definitions of metropolitan areas were first issued in 1949 by the then Bureau of the Budget (predecessor of OMB), under the designation “standard metropolitan area” (SMA). The term was changed to “standard metropolitan statistical area” (SMSA) in 1959, and to “metropolitan statistical area” (MSA) in 1983. The term “metropolitan area” (MA) was adopted in 1990 and referred collectively to metropolitan statistical areas (MSAs), consolidated metropolitan statistical areas (CMSAs), and primary metropolitan statistical areas (PMSAs). The term “core based statistical area” (CBSA) became effective in 2000 and refers collectively to metropolitan and micropolitan statistical areas.

OMB has been responsible for the official metropolitan areas since they were first defined, except for the period 1977 to 1981, when they were the responsibility of the Office of Federal Statistical Policy and Standards, Department of Commerce. The standards for defining metropolitan areas were modified in 1958, 1971, 1975, 1980, 1990, and 2000.

Defining Metropolitan and Micropolitan Statistical Areas

The 2000 standards provide that each CBSA must contain at least one urban area of 10,000 or more population. Each metropolitan statistical area must have at least one urbanized area of 50,000 or more inhabitants. Each micropolitan statistical area must have at least one urban cluster of at least 10,000 but less than 50,000 population.

Under the standards, the county (or counties) in which at least 50 percent of the population resides within urban areas of 10,000 or more population, or that contain at least 5,000 people residing within a single urban area of 10,000 or more population, is identified as a “central county” (counties). Additional “outlying counties” are included in the CBSA if they meet specified requirements of commuting to or from the central counties. Counties or equivalent entities form the geographic “building blocks” for metropolitan and micropolitan statistical areas throughout the United States and Puerto Rico.

If specified criteria are met, a metropolitan statistical area containing a single core with a population of 2.5 million or more may be subdivided to form smaller groupings of counties referred to as “metropolitan divisions.”

As of Jun. 6, 2000, there are 362 metropolitan statistical areas and 560 micropolitan statistical areas in the United States. In addition, there are 8 metropolitan statistical areas and 5 micropolitan statistical areas in Puerto Rico.

Principal Cities and Metropolitan and Micropolitan Statistical Area Titles

The largest city in each metropolitan or micropolitan statistical area is designated a “principal city.” Additional cities qualify if specified requirements are met concerning population size and employment. The title of each metropolitan or micropolitan statistical area consists of the names of up to three of its principal cities and the name of each state into which the metropolitan or micropolitan statistical area extends. Titles of metropolitan divisions also typically are based on principal city names but in certain cases consist of county names.

Defining New England City and Town Areas

In view of the importance of cities and town in New England, the 2000 standards also provide for a set of geographic areas that are defined using cities and towns in the six New England states. The New England city and town areas (NECTAs) are defined using the same criteria as metropolitan and micropolitan statistical areas and are identified as either metropolitan or micropolitan, based, respectively, on the presence of either an urbanized area of 50,000 or more population or an urban cluster of at least 10,000 but less than 50,000 population. If the specified criteria are met, a NECTA containing a single core with a population of at least 2.5 million may be subdivided to form smaller groupings of cities and towns referred to as New England city and town area divisions.

Changes in Definitions over Time

Changes in the definitions of these statistical areas since the 1950 census have consisted chiefly of:

the recognition of new areas as they reached the minimum required city or urbanized area population, and

the addition of counties (or cities and towns in New England) to existing areas as new decennial census data showed them to qualify.

In some instances, formerly separate areas have been merged, components of an area have been transferred from one area to another, or components have been dropped from an area. The large majority of changes have taken place on the basis of decennial census data. However, Census Bureau data serve as the basis for intercensal updates in specified circumstances.

Because of these historical changes in geographic definitions, users must be cautious in comparing data for these statistical areas from different dates. For some purposes, comparisons of data for areas as defined at given dates may be appropriate; for other purposes, it may be preferable to maintain consistent area definitions. Historical metropolitan area definitions are available for 1999, 1993, 1990, 1983, 1981, 1973, 1970, 1963, 1960, and 1950. For more information, contact the Population Distribution Branch at (301) 763-2419.

Conventional Mortgage Home Price Index: MSA Series, Q1 2003 Release (Source: Freddie Mac)

AKRON Ohio PMSA

ALBANY-SCHENECTADY-TROY N.Y. MSA

ALBUQUERQUE N.M. MSA

ALLENTOWN-BETHLEHEM-EASTON Pa. MSA

ANCHORAGE Ak. MSA

ANN ARBOR Mich. PMSA

APPLETON-OSHKOSH-NEENAH Wis. MSA

ATLANTA Ga. MSA

ATLANTIC-CAPE MAY N.J. PMSA

AUGUSTA-AIKEN Ga.-SC MSA

AUSTIN-SAN MARCOS Tex. MSA

BAKERSFIELD Calif. MSA

BALTIMORE Md. PMSA

BARNSTABLE-YARMOUTH Mass. MSA

BATON ROUGE La. MSA

BELLINGHAM Wash. MSA

BERGEN-PASSAIC N.J. PMSA

BIRMINGHAM Ala. MSA

BLOOMINGTON-NORMAL Ill. MSA

BOISE CITY Id. MSA

BOSTON Mass.-NH PMSA

BOULDER-LONGMONT Colo. PMSA

BREMERTON Wash. PMSA

BRIDGEPORT Conn. PMSA

BROCKTON Mass. PMSA

BUFFALO-NIAGARA FALLS N.Y. MSA

BURLINGTON Vt. MSA

CANTON-MASSILLON Ohio MSA

CEDAR RAPIDS Iowa MSA

CHARLESTON-NORTH CHARLESTON S.C. MSA

CHARLOTTE-GASTONIA-ROCK HILL N.C.-SC MSA

CHATTANOOGA Tenn.-GA MSA

CHICAGO Ill. PMSA

CINCINNATI Ohio-KY-IN PMSA

CLEVELAND-LORAIN-ELYRIA Ohio PMSA

COLORADO SPRINGS Colo. MSA

COLUMBIA S.C. MSA

COLUMBUS Ohio MSA

DALLAS Tex. PMSA

DANBURY Conn. PMSA

DAVENPORT-MOLINE-ROCK ISLAND Iowa-IL MSA

DAYTON-SPRINGFIELD Ohio MSA

DAYTONA BEACH Fla. MSA

DENVER Colo. PMSA

DES MOINES Iowa MSA

DETROIT Mich. PMSA

EUGENE-SPRINGFIELD Ore. MSA

EVANSVILLE-HENDERSON Ind.-KY MSA

FLINT Mich. PMSA

FORT COLLINS-LOVELAND Colo. MSA

FORT LAUDERDALE Fla. PMSA

FORT MYERS-CAPE CORAL Fla. MSA

FORT WAYNE Ind. MSA

FORT WORTH-ARLINGTON Tex. PMSA

FRESNO Calif. MSA

GARY Ind. PMSA

GRAND RAPIDS-MUSKEGON-HOLLAND Mich. MSA

GREEN BAY Wis. MSA

GREENSBORO-WINSTON-SALEM-HIGH POINT MSA

GREENVILLE-SPARTANBURG-ANDERSON S.C. MSA

HAMILTON-MIDDLETOWN Ohio PMSA

HARRISBURG-LEBANON-CARLISLE Pa. MSA

HARTFORD Conn. PMSA

HONOLULU Hi. MSA

HOUSTON Tex. PMSA

HUNTSVILLE Ala. MSA

INDIANAPOLIS Ind. MSA

JACKSON Miss. MSA

JACKSONVILLE Fla. MSA

JANESVILLE-BELIOT Wis. MSA

KALAMAZOO-BATTLE CREEK Mich. MSA

KANSAS CITY Mo.-KS MSA

KNOXVILLE Tenn. MSA

LANCASTER Pa. MSA

LANSING-EAST LANSING Mich. MSA

LAS VEGAS Nev.-AZ MSA

LAWRENCE Mass.-NH PMSA

LEXINGTON Ky. MSA

LINCOLN Neb. MSA

LITTLE ROCK-NORTH LITTLE ROCK Ariz. MSA

LOS ANGELES-LONG BEACH Calif. PMSA

LOUISVILLE Ky.-Ind. MSA

LOWELL Mass.-NH PMSA

MACON Ga. MSA

MADISON Wis. MSA

MANCHESTER N.H. PMSA

MELBOURNE-TITUSVILLE-PALM BAY Fla. MSA

MEMPHIS Tenn.-AR-MS MSA

MIAMA Fla. PMSA

MIDDLESEX-SOMERSET-HUNTERDON N.J. PMSA

MILWAUKEE-WAUKESHA Wis. PMSA

MINNEAPOLIS-ST. PAUL Minn.-Wis. MSA

MODESTO Calif. MSA

MONMOUTH-OCEAN N.J. PMSA

NASHUA N.H. PMSA

NASHVILLE Tenn. MSA

NASSAU-SUFFOLK N.Y. PMSA

NEW HAVEN-MERIDEN Conn. PMSA

NEW ORLEANS La. MSA

NEWYORK N.Y. PMSA

NEWARK N.J. PMSA

NORFOLK-VIRGINIA BEACH-NEWPORT NEWS MSA

OAKLAND Calif. PMSA

OKLAHOMA CITY Okla. MSA

OLYMPIA Wash. PMSA

OMAHA Neb.-IA MSA

ORANGE COUNTY Calif. PMSA

ORLANDO Fla. MSA

PEORIA-PEKIN Ill. MSA

PHILADELPHIA Pa.-NJ PMSA

PHOENIX-MESA Ariz. MSA

PITTSBURGH Pa. PMSA

PORTLAND-VANCOUVER Ore.-WA PMSA

PROVIDENCE-FALLS RIVER-WARWICK R.I.-Mass. MSA

PROVO-OREM Utah MSA

RACIN Wis. PMSA

RALEIGH-DURHAM-CHAPEL HILL N.C. MSA

READING Pa. MSA

RENO Nev. MSA

RICHMOND-PETERSBURG Va. MSA

RIVERSIDE-SAN BERNARDINO Calif. PMSA

ROANOKE Va. MSA

ROCHESTER N.Y. MSA

ROCKFORD Ill. MSA

SACRAMENTO Calif. PMSA

SAGINAW-BAY CITY-MIDLAND Mich. MSA

ST. LOUIS MO-Ill. MSA

SALEM Ore. PMSA

SALINAS Calif. MSA

SALT LAKE CITY-OGDEN Utah MSA

SAN ANTONIO Tex. MSA

SAN DIEGO Calif. MSA

SAN FRANCISCO Calif. PMSA

SAN JOSE Calif. PMSA

SAN LUIS OBISPO-ATASCADERO-PASO ROBL MSA

SANTA BARBARA-SANTA MARIA-LOMPOC Calif. MSA

SANTA CRUZ-WATSONVILLE Calif. PMSA

SANTA FE N.M. MSA

SANTA ROSA Calif. PMSA

SARASOTA-BRADENTON Fla. MSA

SEATTLE-BELLEVUE-EVERETT Wash. PMSA

SPOKANE Wash. MSA

SPRINGFIELD Ill. MSA

SPRINGFIELD Mass. MSA

STAMFORD-NORWALK Conn. PMSA

STOCKTON-LODI Calif. MSA

SYRACUSE N.Y. MSA

TACOMA Wash. PMSA

TAMPA-ST. PETERSBURG-CLEARWATER Fla. MSA

TOLEDO Ohio MSA

TRENTON N.J. PMSA

TUCSON Ariz. MSA

TULSA Okla. MSA

VALLEJO-FAIRFIELD-NAPA Calif. PMSA

VENTURA Calif. PMSA

VISALIA-TULARE-PORTERVILLE Calif. MSA

WASHINGTON D.C.-MD-VA-WV PMSA

WEST PALM BEACH-BOCA RATON Fla. MSA

WICHITA Kans. MSA

WILMINGTON-NEWARK Del.-MD PMSA

WORCESTER Mass.-CT PMSA

YOLO Calif. PMSA

YORK Pa. MSA

It should be noted that for such real estate index linked financial instruments to operate in an open market, parties have to agree on the precise index to be used, as the next published numbers of this index will trigger a change in value of the financial instruments. Furthermore, it will be apparent to one skilled in the relevant art(s) the parties may need to define all terms of the contract within the contract itself to avoid legal disputes. It should also be noted that prices on real estate index linked financial instruments may be quoted in either fraction or decimal formats.

Derivatives, being financial instruments, may be traded among investors as are stocks, bonds, and the like. Thus, in order to trade derivatives, there must be a mechanism to price them so that traders may exchange them in an open market. To date, there is no organized exchange for real estate index linked financial instruments (or derivates, as they may be alternately referred to in these descriptions of the present invention), as they are traded as over-the-counter (OTC) instruments, typically between two counterparties conducting a private transaction not open to other investors. The present invention of real estate index linked financial instruments would be made available via exchanges (both electronic and open outcry), ECNs (electronic commerce networks such as Instinet or Archipelago), broker/dealer networks (e.g. Everen Securities) and via OTC (over the counter) transactions and via private transactions between two or more counterparties or legal entities.

The relationship between the value of a derivative and the underlying asset are not linear and can be very complex. Economists have developed pricing models in order to perform valuation of certain types of derivatives. As is well known in the relevant art(s), the Black-Scholes option pricing model is the most influential and extensively used pricing model. The Black-Scholes model is based on stochastic calculus and is described in detail in a variety of publicly available documents, such as Chriss, Neil A., The Black-Scholes and Beyond Interactive Toolkit: A Step-by-Step Guide to In-depth Option Pricing Models, McGraw-Hill, 1997, ISBN: 078631026X (USA), which is incorporated herein by reference in its entirety.

Whether using the Black-Scholes or any other pricing model, each has inherent flaws and thus poses risks. It has been estimated that some 40% of losses in dealing with derivatives can be traced to problems related to pricing models. Risks in relying on any model include errors in the model's underlying assumptions, errors in calculation when using the model, and failure to account for variables (i.e., occurrences) that may affect the underlying assets.

Real estate indices, and more specifically future expected movement in such indices, have not yet been an area of application for pricing models. The few models that have considered real estate prices usually have only considered past (i.e., historical) real estate price or index data. That is, most models assume, for example, that real estate prices are cyclical in nature. Historical analysis has shown, however, that this assumption does not always hold true. Thus, regardless of the index or instrument, risk management trading techniques or vehicles, traders essentially have been operating in the “blind” without knowledge of real estate predicted future index movements.

Therefore, given the fact that real estate index linked financial instruments and/or derivatives have been overlooked in the development of financial products, existing models have considered past real estate indices, and also with respect to the newly-developed present invention described in this document, what is needed is a mechanism to price real estate index-linked financial instruments so that parties may exchange them in an open market. The mechanisms used to price real estate-linked financial instruments may include, but is not limited to, the following:
1. Black-Scholes Option Pricing Model
2. Binomial Lattice Models
3. Trinomial Lattice Models
4. Monte Carlo Simulations
   Black-Scholes Model

The Black-Scholes model developed in 1972 was the original option-pricing model for the valuation of European style options. European style options are options that have as a characteristic that they cannot be exercised before the expiration date. Its principles serve as the foundation in almost all options formulas used today.

Fischer Black and Myron Scholes developed their option pricing model under the assumptions that the underlying prices change continuously and that the returns of the underlying follow a log-normal distribution. Also, they assume that the interest rate and the volatility of the underlying remain constant over the life of the option.

The Black-Scholes model as originally developed pertained only to options on underlying with no dividend payment. The calculator used here has been adjusted for the Black-Scholes model to account for dividends.

The Black-Scholes equation is usually written as C=S*N(d₁)−Ke^{-(rt)}*N(d₂), where the notation is fairly standard, as described by P. Wilmott, J. N. Dewynne and S. Howison, “Option Pricing: Mathematical Models and Computation”, Oxford Financial Press, Oxford (1993).

Binomial Option Pricing Model

An option pricing model in which the underlying asset can assume one of only two possible, discrete values in the next time period for each value that it can take on in the preceding time period. This is a simple model used to price options by reducing possibilities of price changes, removing the possibility for arbitrage, assuming perfectly efficient markets, and shortening the duration of the option. The binomial approach assumes a risk neutral approach to valuation, assuming that underlying security prices can only increase or decrease with time until the option expires worthless.

The binomial model, developed by Cox and Rubinstein, breaks down the time to expiration into potentially a very large number of time intervals, or steps. A tree of the underlying prices is initially produced working forward from the present to expiration.

At each step it is assumed that the underlying price will move up or down by an amount calculated using volatility and time to expiration. This produces a binomial distribution, or recombining tree, of underlying prices. The tree represents all the possible paths that the underlying price could take during the life of the option. At the end of the tree—i.e. at expiration of the option—all the terminal option prices for each of the final possible stock prices are known, as they simply equal their intrinsic values.

The option prices at each step of the tree are calculated working back from expiration to the present. The option prices at each step are used to derive the option prices at the next step of the tree using risk neutral valuation based on the probabilities of the underlying prices moving up or down, the risk free rate and the time interval of each step. At the top of the tree there will only be left one option price, which is known as the theoretical or fair value of the option.

For European options, the binomial model converges on the Black-Scholes formula as the number of steps in the binomial calculation increases. In fact the Black-Scholes model for European options is really a special case of the binomial model where the number of binomial steps is infinite. In other words, the binomial model provides discrete approximations to the continuous process underlying the Black-Scholes model.

To derive the formula for Binomial pricing model, begin by dividing the life of an option into a large number of small time intervals of length dt. Assuming that the initial value of the index is S, the value S can increase to Sᵤ or decrease to S_{d} when comes to the next time interval. Hence index can move from its initial value of S to one of two new values, Sᵤ and S_{d}. The movement from S to Sᵤ is therefore an “up” movement and the movement from S to S_{d} is a “down” movement. The probability of an up movement will be denoted by p while the probability of a down movement is (1−p).

Trinomial Model

The Trinomial Model is very similar to the Binomial Model except that at each time interval it is assumed that the underlying index (S) will move up (Sᵤ) or down (S_{d}) by an amount or remain the same (S). The initial index level, interest rates and the volatility define the nature of the trinomial lattice. If the probability of an up movement is denoted as pᵤ while the probability of a down movement is denoted by p_{d}, the probability for the across movement will be (1−pᵤ−p_{d}).

Once the array of the underlying index has been set up by working forwards through the trinomial tree, the option price array is calculated by working backwards from the option expiry. At option expiry, the options are initialized to their intrinsic value. In discounting back from the expiry to the present, the option price at each interval is calculated as the minimum of the exercise (strike) price and the discounted value of holding the option over the time period. Once the option price array has been populated, the theoretical (fair) option value is the value of the option at t=0 or at present.

Monte Carlo Simulation

An analytical technique for solving a problem by performing a large number of trial runs, called simulations, to analyze the effect of varying inputs on the outputs of a model, such as a stock price. The simulations will infer a solution from the collective results of the trial runs. The Monte Carlo simulation randomly generates values for uncertain variables over and over to simulate a model, and calculates the probability distribution of possible outcomes.

Other Methods

While Black-Scholes model is a popular model used for option pricing, other models exist that consider different factors. No model can be entirely accurate. The pricing models used here are not intended to provide a complete list of methodologies for valuing financial instruments, but rather as an exploration of the many ways in which financial instruments can be assessed in order for a trader to determine whether an instrument is a desirable investment or not. In fact, as will be readily apparent to those skilled in the relevant art(s), there are a multitude of methodologies, formulae and pricing models by which one can determine whether a financial instrument is over-, under- or fairly priced when compared with its market value. Examples of alternative methodologies would include, but are not limited to, closed form solutions and neural networks.

Also, as a workflow to be included in a preferred embodiment of the present invention, “black box” computer programs may be used, wherein the user enters information and the system utilizes pre-programmed logic (e.g. formulas, calculations) to return output to the user, which may include by way of example buy or sell signals and other optimal or useful information output.

Option Model Inputs

By way of example, there are eight inputs for a call or put option:

Option Type: A Call or a Put

Underlying Price: Value of the underlying index or indices, e.g. Atlanta MSA

Exercise Price of Option: Strike price of the Option e.g. 140

Dividend Yield: In percentage. e.g. 1.72%

Interest Rate: In percentage. e.g. 3.12%

Volatility: In percentage. e.g. 25%

Valuation Date: e.g. Oct. 9, 2004

Exercise Date: e.g. Jan. 7, 2005

Other types of real estate index linked financial instruments may require additional inputs.

Additional valuation measures like Intrinsic Value, Time Value and Implied Volatility of real estate index linked financial instruments will be calculated immediately upon input of the financial instrument's market value.

Intrinsic Value and Time Value

The intrinsic value of a call is the amount by which the index is above the call's strike price. The intrinsic value of a put is the amount by which the index is below the put's exercise price. Time value is that portion of an option's total price in excess of intrinsic value. As the intrinsic value increases, the time value decreases.

Consider the following illustration: A call and a put on the same underlying has the same exercise price of 700. Current underlying price is at 720, the call costs RM 25 and the put costs RM 5. The intrinsic value of the call is 20 (=720−700) and of the put is 0 (since the index is above the put's exercise price). The time value of the call is 5 (=25−20) while that of the put is 5 (=5−0).

Implied Volatility

Implied volatility is the volatility percentage that explains the current market price of a financial instrument. As the forces of supply and demand determine the market price of a financial instrument, the volatility percentage must be adjusted to explain the market price of the financial instrument. The implied volatility that produces the financial instrument's market price as the theoretical value is the implied volatility.

3. Overview of The Present Invention

The present invention involves a system, method, and computer program product for the valuation (and thus, processing and trading) of real estate index linked financial instruments, and/or financial instruments that are affected by real estate indices. In an embodiment of the present invention, an organization which trades real estate index linked financial instruments may provide a brokerage desk that facilitates trades of such instruments either for clients or for its own proprietary account, as well as providing an interactive World Wide Web site accessible via the global Internet for real estate predicted future indices and index information, pricing models, and trade execution services. The organization may also provide information and data sets that enable traders to identify and capitalize on market fluctuations affecting or driven by real estate prices and index prices or values. The infrastructure supporting these operations may be an organized electronic exchange, open outcry exchange, broker/dealer system, ECN (electronic commerce network), or OTC process for real estate index linked financial instruments. Such real estate index linked financial instruments may also be created as custom products for particular entities, and may only be tradeable to another entity or entities which wish to take delivery of such a custom real estate index linked financial instrument.

Such a system could also allow entities to intelligently trade and use real estate index linked financial instruments not only to manage real estate-related market risks, but also to speculate for profit. These entities may trade with each other in any multi-party combination or with internal legal entities, and include but are not limited to:
1. Sovereign governments (e.g. United States)
2. Government agencies (e.g. Fannie Mae, Freddie Mac, Ginnie Mae)
3. Non-governmental organizations (e.g. International Monetary Fund, World Bank, Inter-American Development Bank)
4. Pan-governmental organizations and treaty organizations (e.g. European Union, African Union, Mercosur, NAFTA)
5. Territorial governments (e.g. Puerto Rico, U.S. or U.K. Virgin Islands, Macau, Greenland)
6. Autonomous or semi-autonomous/privileged regions contained within a sovereign entity (e.g. Hong Kong [of the People's Republic of China])
7. Provisional governments
8. Governments recognized by at least one other member of the United Nations (e.g. Republic of China a.k.a. Taiwan [recognized only by Sao Tome], Turkish Cyprus [recognized only by Turkey])
9. Commercial banks
10. Investment banks
11. Commercial/Investment banks (e.g. Citigroup)
12. Investment boutique firms
13. Private equity firms (e.g. Carlyle Group)
14. Commodity trading entities (including fuel and power, such as Dynegy, the former Enron, and the former Mirant)
15. OTC trading entities
16. Insurance companies (e.g. Aetna)
17. Reinsurance companies (e.g. Munich Re)
18. Insurance/financial services hybrids (e.g. AIG, Citigroup [Travelers])
19. Mutual funds (e.g. Vanguard, Fidelity)
20. Venture capital funds (e.g. Kleiner Perkins Caufield Byers)
21. Hedge funds
22. Broker/dealer networks (e.g. Everen Securities)
23. Electronic brokers (e.g. E-trade)
24. Electronic commerce networks (e.g. Instinet or Archipelago)
25. Open outcry exchanges and their members (e.g. AMEX, a.k.a. American Stock Exchange)
26. Real estate investment trusts (commonly known as REITs)
27. Retail investors of any level (such as individual/proprietor, partnership, limited liability company, S corporation, and C corporation, either public or private.)

The present invention is designed to support a variety of business and regulatory requirements for any of these parties transacting with each other in the trade of real estate index linked financial instruments.

The present invention is described in terms of the above example. This is for convenience only and is not intended to limit the application of the present invention. In fact, after reading the following description, it will be apparent to one skilled in the relevant art how to implement the following invention in alternative embodiments and without limitation for the benefit of anyone whose “bottom line” can be affected by investing in real estate index linked financial instruments.

II. System Architecture Overview

A. System Components

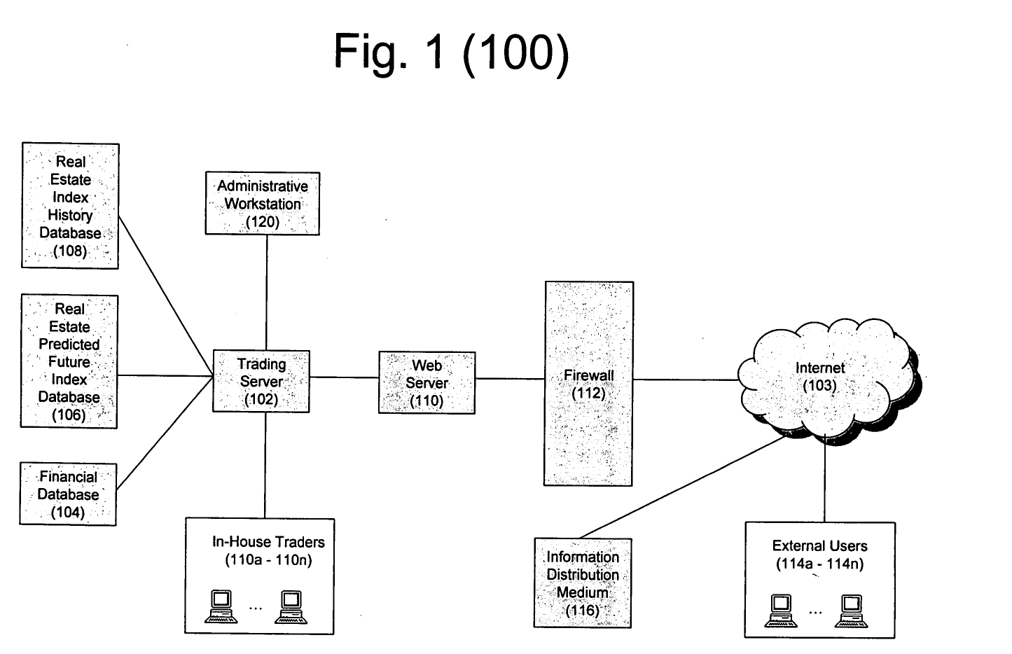

Referring to FIG. 1, a real estate index linked trading system 100, according to an embodiment of the present invention, is shown. It should be understood that the particular trading system 100 in FIG. 1 is shown for illustrative purposes only and does not limit the invention. Other implementations for performing the functions described herein will be apparent to persons skilled in the relevant art(s) based on the teachings contained herein, and the invention is directed to such other implementations. As will be apparent to one skilled in the relevant art(s), all of components “inside” of the trading system 100 are connected and communicate via a communication medium such as a local area network (LAN) 101.

The trading system 100 includes a trading server 102 that serves as the “back-end” (i.e., real estate index processing system) of the present invention. Connected to the trading server 102 is a financial database 104, a real estate index history database 108, and/or a real estate predicted future index database 106. The trading server 102 is also connected to a Web server 110. As is well-known in the relevant art(s), a Web server is a server process running at a Web site which sends out web pages in response to Hypertext Transfer Protocol (HTTP) requests from remote browsers. The Web server 110 serves as the “front end” of the present invention. That is, the Web server 110 provides the graphical user interface (GUI) to users of the trading system 100 in the form of Web pages. Such users may access the Web server 110 at the real estate index trading organization's site via a plurality of internal workstations 110 (shown as workstations 110a-n).

A firewall 112 serves as the connection and separation between the LAN 101, which includes the plurality of network elements (i.e., elements 102-110 and 120) “inside” of the LAN 101, and the global Internet 103 “outside” of the LAN 101. Generally speaking, a firewall—which is well-known in the relevant art(s)—is a dedicated gateway machine with special security precaution software. It is typically used, for example, to service Internet 103 connections and dial-in lines, and protects a cluster of more loosely-administered machines hidden behind it from an external invasion.

The global Internet 103, outside of the LAN 101, includes a plurality of external workstations 114 (shown as workstations 114a-n). The external workstations 114 allow client-users (traders) of the real estate index trading organization to remotely access and use the trading system 100.

The trading system 100 includes an administrative workstation 120 that may be used by the trading organization to update, maintain, monitor, and log statistics related to the server 102 and the trading system 100 in general. Furthermore, FIG. 1 depicts an information distribution medium 116 connected to the Internet 103. This is to signify that information distribution medium s 116 or other information distribution tools may access trading system 100 for the purposes of, but not limited to, publishing the trading organization's real estate predicted future indices for users, according to an embodiment of the present invention.

While one trading server computer 102 is shown in FIG. 1, it will be apparent to one skilled in the relevant art(s) that trading system 100 may be run in a distributed fashion over a plurality of the above-mentioned network elements connected via LAN 101. Similarly, while several databases (i.e., 104, 106, and 108) are shown in FIG. 1, it will be apparent to one skilled in the relevant art(s) that trading system 100 may utilize databases physically located on one or more computers which may or may not be the same as sever 102. More detailed descriptions of the trading system 100 components, as well as their functionality, are provided below.

1. Real Estate Index History Database

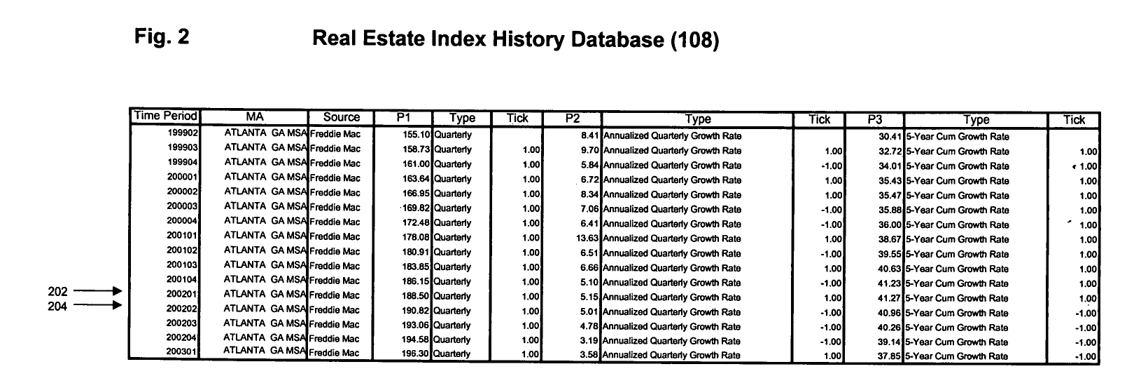

An example real estate index history database 108 is shown in FIG. 2. The real estate index history database 108 includes, for each time period in the view, one or more records for each metropolitan area (MA). (The term MA closely resembles the well-known name Metropolitan Statistical Area (MSA). However MA encompasses a larger surrounding geographical area/region than the strict MSA definition. However, since MA and MSA are similar, they are used interchangeably herein, and the use of either MA or MSA should not preclude understanding of the other term for the purposes of understanding the present invention). The real estate index history database 108 contains but is not limited to data on metropolitan areas, and could include but is not limited to localities, cities, regions, states, nations, or multinational/international areas. These records contain information specifying the real estate index information that occurred in the subject MA in the time span represented in the view. Specifically, for each MA, there is a record for each of several real estate index data types.

In an embodiment of the present invention, the real estate index history database 108 contains all past historical real estate index data including the most recently published or “present” value. There are different classes of real estate index data types in the real estate index history database 108. Classes of index values may be defined by a variety of time periods and with different methods of summarizing information. The classes may include, but are not limited to, quarterly index values, quarterly growth rates, annualized quarterly rates, moving quarterly averages, annual index values, annual growth rates, moving annual averages, five-year index values, five-year growth rates, five-year annualized growth rates, and moving five-year averages. As will be apparent to one skilled in the art(s), other time periods and summarization techniques may be used to present information on real estate indices within real estate index history database 108.

The “tick” columns in FIG. 2 simply denote whether a change in a real estate index value is an uptick or downtick. An uptick or increase in the value of the index sets the tick value to 1, while a downtick or decrease in the value of the index sets the tick value to −1. If there is no change in value, the tick value equals 0. Of course, values other than 1, 0, and −1 could be alternatively used to indicate these relationships. Also, other real estate index data types may be used, and the processing of tick values may be applied across both the real estate index history database 108 and the real estate predicted future index database 106. Each recorded tick (either uptick or downtick) in the price of a security is written to the real estate index history database, for the purpose of keeping track of the number and value of consecutive incremental price movements (both upwards and downwards) for the real estate index-linked financial instrument in question. The real estate index history database is updated after each trade by performing a write SQL statement which adds the abovementioned information.

The historical real estate index information in the real estate index history database 108 is provided on a per period basis. As indicated above, the period may be any increment of time, such as intraday, daily, weekly, bi-weekly, monthly, bimonthly, quarterly, semi-annually, annually, etc. Preferably, the increment of time represented by a period is the same in both of the real estate index databases (106 and 108) within trading system 100.

Each real estate index includes one or more data components. For example, the MSA for Atlanta, Ga. includes quarterly growth rates, annualized quarterly growth rates, five-year cumulative growth rates, and other elements. For any given period, the values of these data components comprising the real estate indices are represented by the entries in the real estate index history database 108 and are linked to the appropriate category data type. For example, in the first quarter of 2002, the quarterly growth rate for the Atlanta MSA was 1.26% to an index value of 188.5, from a previous MSA index value of 186.15 in the fourth quarter of 2001 (see records 202 and 204 in FIG. 2 for a general representation). This real estate index value may be replicated in a reference file where it is stored in an abbreviated format called P₁R₁, with P₁ representing the period of time and R₁ representing the particular real estate index to be referenced. This file is used as the “look up” to allow the system to determine which instrument values will change in response to the change in the underlying real estate index (in this example, the Atlanta MSA value).

2. Real Estate Predicted Future Index Database

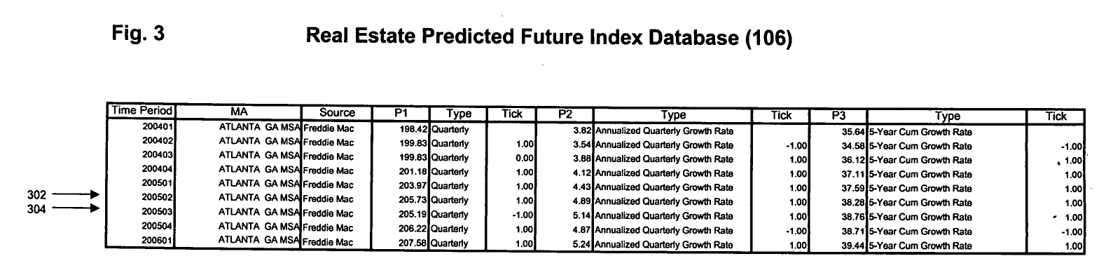

An example real estate predicted future index database 106 is shown in FIG. 3. The real estate predicted future index database 106 includes, for each future time period in the view, one or more records for each MA. These records contain information specifying the real estate index value that is predicted to occur in the subject MA in the future time span represented in the view. Specifically, for each MA, there is a record for each of several real estate index data types.

The real estate index predicted future database also contains several classes of real estate index data types, as in the real estate index history database 108, which are for a variety of predicted future real estate index values. These categories are the same as those described above with respect to the real estate index history database 108. Accordingly, the description above of the real estate index history database 108 also applies to the real estate index predicted future database 106.

3. Relationship Between Past and Future Databases

As evident by the description above, the real estate index history database 108 is a past database because it contains history information. In contrast, the real estate predicted future index database 106 is a future database because it contains information pertaining to predicted real estate index movement in the future. Both databases contain information on a per period basis. Preferably, the increment of time represented by a period is the same in both databases. Also, the periods in both databases are synchronized in order to aid the transfer of information between the two databases.

4. Time Periods

As discussed above, data may be stored in the real estate index history database 108 using any time increment or period, including but not limited to daily, weekly, monthly, quarterly, etc. Similarly, real estate predicted future index information for each location may be stored in the real estate predicted future index database 106 on a daily basis, a weekly basis, a monthly basis, or a quarterly basis. Preferably, the time increment/period is the same in both databases 108 and 106. In practice, a system administrator will select the time increment(s)/period(s) during an administrator setup process using administration workstation 120 in order to meet the demands of traders using the plurality of workstations 110 and 114.

5. Financial Database

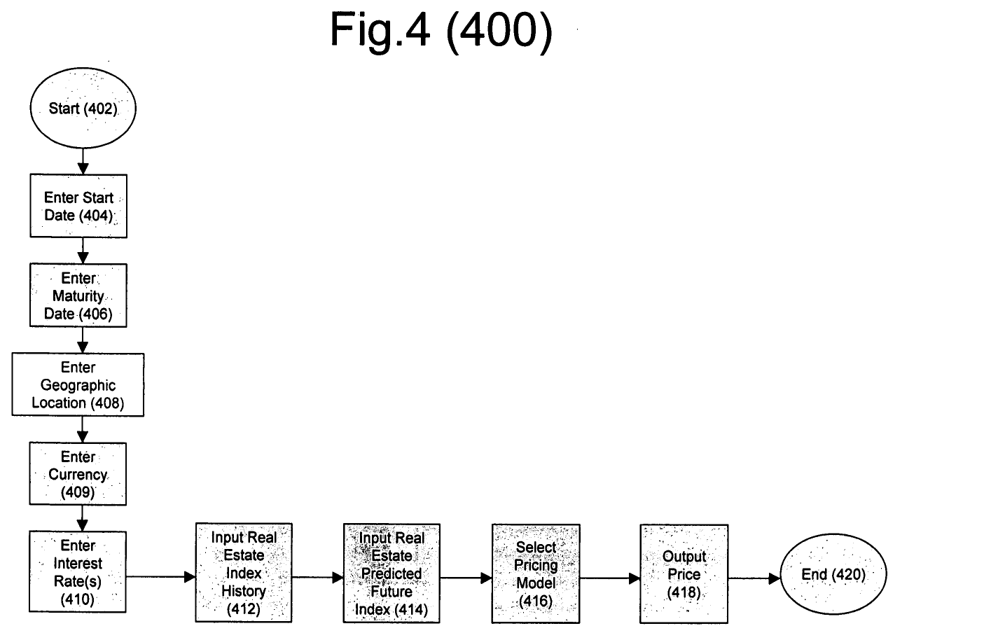

The financial database 104 of trading system 100 contains current financial data that is used by the trading server 102. The financial database 104 includes information relevant to calculating an investment's risk-free rate of return. Such information, as will be apparent to one skilled in the relevant art(s), may include but is not limited to one or more of the Discount Rate, the Prime Interest Rate, the 90-day Treasury Bill, the London Interbank Offered Rate (LIBOR), the Eurodollar Rate, and the like. As will be explained below with reference to FIG. 4, the risk-free rate information within the financial database 104 is necessary for determining the cost-of-cash during the operation of the trading system 100. The financial database 104 may include additional financial information on an application specific basis.

6. Information Retrieval and Dissemination from Databases

The user may choose any number of the above categories of information for display or download for the information in the real estate index history database 108, real estate predicted future database 106, and financial database 104, by an on-screen selection or check list. After the categories of information have been chosen, the user may execute the research via a selection option on the keyboard or via mouse and graphical user interface (GUI). The system then compiles and executes a selection of SQL query calls according to all selections made by the user. The query results are compiled and prepared for display. Once the results are compiled, pre-programmed graph, trend line and textual templates are used to display the query results on the GUI client display for all chosen securities and information categories described above. After display, the user is given the option to download the displayed results and underlying query data. The user is allowed to select from a variety of download formats, such as ASCII, xbase, dbf, HTML, XML, FPML, MDDL, tif, gif, bmp, or the like. The user is allowed to choose a download location on the local client. The system then proceeds to compile the data into the chosen format. The data is then transferred, using any one of a variety of protocols such as zmodem, xmodem, ftp, TCP/IP, or any one of the OS industry standard protocols.

7. Data Feeds and Data Distribution

In a preferred embodiment of the present invention, the real estate index history database 108 and the real estate predicted future index database 106 can provide information for the purpose of distributing information in information distribution medium 116 or for resale as a data feed to a data vendor (including, but not limited to, Bloomberg, Fitch, Moody's, Reuters, Standard & Poor's, Dun and Bradstreet, any physical or electronic exchange, any Small Order Execution Service (SOES) or electronic commerce network (ECN) or broker/dealer network, and/or other commercial services). The data to be distributed could include, but is not limited to, the following:
1. Real estate index historical value per MA per time period
2. Real estate predicted future index value per MA per time period
3. List of real estate index linked financial instruments currently being traded, and/or list of real estate index linked financial instruments that were previously traded but are no longer listed.
4. Number of contracts in circulation per real estate index linked financial instrument (“open interest”)
5. Characteristics of each real estate index linked financial instrument (e.g. volatility, price quoted in either fractional or decimal format, expiry date or alternatively time to maturity, etc.)
6. Metrics linked to the characteristics of real estate index linked financial instruments (e.g. total annual return for the holder of the instrument, total annual portfolio return for the holder of several types of real estate index linked financial instruments, etc.)
7. Last trading price of each particular real estate index linked financial instrument
8. Price movement of last trading price in relation to the previous price movement
9. Price movement since the previous week, previous month, year to date, previous 52 weeks, or over other measurable periods of time, expressed either in discrete terms or in percentage of change.
10. Lists of indices with particular movement qualities, including, by way of example only, “10 best performers” over a measurable time period, “10 worst performers” over a measurable time period, and “10 most active” indices in terms of trading volume of financial instruments of a specific class linked to the indices. As will be apparent to one skilled in the relevant art(s), it is within the scope and spirit of the present invention to allow a variety of combinations in presenting such statistics.
11. Put-call ratio applicable to options on each particular real estate index.
12. Long-short ratio applicable to financial instruments linked to each particular real estate index.
13. Number of total contracts of each type traded in a trading day (“volume”).
14. Currency value, in each applicable currency of denomination, of all trades of each contract type traded in a trading day.
15. Number of buy vs. sell trades executed in a trading day
16. Number of contracts involved in buy trades in a trading day vs. number of contracts involved in sell trades in a trading day.
17. Total short interest in a particular type of real estate index linked financial instrument, expressed either as the discrete volume of contracts sold short for a type of real estate index linked financial instruments, and/or a percentage of the total number of contracts outstanding of a real estate index linked financial instrument that have been sold short.
18. The prevailing stop limit order for each real estate index linked financial instrument, as well as relevant volume figures for the instrument.
19. External factors such as changes in a variety of published interest rates, published inflation rates, and other published economic indicators which may impact real estate index linked financial instruments. By way of example, an increase or decrease in interest rates could trigger algorithmic calculations which affect terms and pricing for many real estate index linked financial instruments and also currency values (e.g. interest rates for money market account funds that have not yet been invested in a real estate index-linked security) tracked within the system.

As will be apparent to one skilled in the relevant art(s), other calculations are possible based upon this list and based upon the present invention in total. For example, by having the total number of buy trades vs. sell trades executed in each trading day, it would be possible to sum up and publish the total number of buy trades vs. sell trades executed in an entire month, or year. In a further embodiment of the present invention, such information may be packaged within a front-end interface GUI module with trade execution, account management, and research reporting capabilities, for sale to and use by users such as individual or institutional traders, analysts, portfolio managers, and others (already noted within these claims for the present invention) as entities whose “bottom line” may be affected by investing in real estate index linked financial instruments. Also, it is an embodiment of the present invention that such data feeds may be either automated or managed manually. Finally, it is another embodiment of the present invention that input streams to the real estate index history database 108 may be taken and sent out again as part of the outbound data streams. Such input streams could include, but are not limited to, data updates received directly from the systems of real estate index publishers such as OFHEO, if such an index publisher has the system that provides data output that would be recognized as data input by the present invention.

It is also a preferred embodiment of the present invention that such data streams may be adjusted to define and output fundamental data relating to the value of a security on given dates with search limitations relating to technical trading rules, holidays, and historical events, business events, government reports, trigger dates (for financial guarantees, by way of example), and even particular days of the week, weeks, months, or years. For example, in the preferred embodiment of the present invention, a user can request a bar chart of U.S. Conventional Mortgage Home Price Indices on all days when the report was released by the U.S. Government, or the data affecting all related and affected interest rates after a prime rate increase. Such a search could be further limited to stipulate that only those occurrences between Memorial Day and Labor Day when the prime rate was over 3% should be output. In addition, in conjunction with real estate index information and real estate index linked financial instrument information, the database may output commonly-available market averages information, such as the Dow Jones averages each day over extended periods, or commonly-available economic indicators information such as the consumer price index, global GNP or GDP figures, real estate sales data, revenues and profits for REITs (for example), and other such indicators, together with the dates upon which this information is released if appropriate, such as, but not limited to: major holidays, government holidays, international holidays and/or foreign holidays, special holidays, triple-witching days, contract expiration days, bear or bull market days, expiry/renewal days for financial guarantees such as letters of credit, and the like. The days and holidays may be denoted for the purpose of system alerts to users. Real estate index linked financial instruments will already carry a maturity date or date of expiration within their definition, so that they will become expired upon either exercise prior to the maturity date of the instrument, or will become expired if the maturity date passes without any exercise action on the part of the holder of the financial instrument.

III. The Black-Scholes Pricing Model

Before detailing the operation of the present invention, it is important to detail the specifics of the Black-Scholes pricing model. It is noted that, for illustrative purposes only, the invention is described with reference to the Black-Scholes pricing model. However, the invention is not limited to this embodiment. Instead, embodiments of the invention utilize variations of the Black-Scholes pricing model discussed herein. Also, other embodiments of the invention utilize pricing models other than the Black-Scholes model, such as binomial models, trinomial models, Monte Carlo simulations, closed form solutions and neural networks. The following description applies to such other embodiments of the invention. The Black-Scholes formula for determining the price of a call option, C, using the five parameters essential to the pricing of an option: (1) the strike price K; (2) the time to expiration t, (3) the underlying commodity price S; (4) the volatility of the commodity a (“sigma”); and (5) the prevailing interest rate r, is shown in equation (2):
C=S*N(d₁)−Ke^{-(rt)}*N(d₂) (2)

As will be apparent to one skilled in the relevant art(s), e is the exponential function—the inverse of the natural logarithm ln—that is equal to, up to four significant decimal places, 2.7183. The variables d₁ and d₂ within equation (2) are expressed as shown in equations (3A) and (3B), respectively:
d₁=[ln(S/K)+(r+σ²/2)^{t}]σ√t (3A)
d₂=d1−σ√t (3B)

The function “N( )” is the standard normal distribution function, which, as is well known in the relevant art(s), may be accurately approximated for any value z using equation (4):
N(z)=1−(1/(√2*π)*e^{-z2/2}*(b1*k+b2*k²+b3*k³) (4)

Further, the variable k used in equation (4) is defined as shown in equation (5):
k=1/(1+a*z) (5)

The values a, b1, b2, b3 are constants equal to {a=0.33267; b1=0.4361836; b2=−0.1201676; and b3=0.937298}.

Having presented the Black-Scholes formula for a call option, equation (6) describes the expression for the price P of a put option:
P=C−S+Ke^{-(rt)} (6)

Having presented the Black-Scholes pricing model, the operation of the present invention and its application to pricing real estate index linked financial instruments may now be explained. However, as indicated above, while the present invention is described in terms of adopting the Black-Scholes model to apply to real estate index linked financial instruments, it will be apparent to one skilled in the relevant art(s), that other pricing models may be so adopted. Examples of these alternative pricing models have already been discussed, including but not limited to binomial models, trinomial models, Monte Carlo simulations, and other models including but not limited to closed form solutions and neural networks.

IV. General System Operation

Referring to FIG. 4, a flowchart 400 representing the operation of trading system 100, according to an embodiment of the present invention, is shown. Flowchart 400 begins at step 402 with control passing immediately to step 404.

A. Inputs

In steps 404 and 406, the start date and the maturity date, respectively, of the contract are entered into the real estate index trader server 102 of trading system 100. In step 408, the geographic location (or region) which serves as the subject of the contract is entered. The geographic location can be a single location or multiple locations. That is, the geographic location may be a single MSA or a collection (i.e., “basket”) which includes a plurality of different MSAs each of which could have different weightings in the basket. In step 409, the currency denomination which serves as the basis of the contract is entered (in some embodiments, multiple currency terms can be entered in any number of inter-relationships). Then, in step 410, the cost of cash is entered. The cost of cash (i.e., the risk-free rate) information may be read from the financial database 104 of the trading system 100, or may be obtained from another source, including, but not limited to, an on-line financial service. The above information may be entered by a user by using a graphical user interface screen, for example.

In an embodiment of the present invention, the user of system 100 may enter the time period (steps 404 and 406), the geographic location (step 408), and the currency(s) of denomination (step 409), and the real estate index history and real estate predicted future index information, as well as financial information, will automatically be retrieved from the appropriate databases (see FIG. 1) to populate the GUI screen.

B. Processing and Output

In step 412, the real estate index history database 108 is read so that the trading server 102 has the correct information for processing. The information read from the real estate index history database 108 includes the past real estate index information for one or more fixed past time periods for the geographic location(s) entered in step 408. Alternatively, the trading server 102 could query and obtain the real estate index information from some other source, such as a commercial service. As mentioned above, real estate index history database 108 contains the data necessary to provide the trading server 102 the particular real estate index information, including currency denomination and related regulatory terms, which serve as the basis for the contract.

In step 414, the real estate predicted future index 106 is read so that the trading server 102 has the correct information for processing. That is, the trading server 102 would query the real estate predicted future index database 106 (or obtain the information from some other source, such as a commercial service) for the period represented by the start and maturity dates entered in steps 404 and 406, respectively. As mentioned above, real estate predicted future index database 106, similar to real estate index history database 108, contains the data necessary to provide the trading server 102 with the particular real estate information (including currency denomination) which serves as the basis for the contract as entered in step 409. During step 414, the real estate index server 102 may identify the real estate predicted future index movement pattern that occurs in the future time period specified by steps 404 and 406. Consider, for example, real estate predicted future index database 106 shown in FIG. 3. As indicated by records 302 and 304, the real estate predicted future index movement pattern in the Atlanta, Ga. MSA in future period T₁ may be replicated in a reference file where it is stored in an abbreviated format called T₁R₁, with T₁ representing the period of time and R₁ representing the particular real estate index to be referenced. This file is used as the “look up” to allow the system to determine which instrument values will change in response to the change in the predicted future value of the underlying real estate index (in this example, the Atlanta MSA value).

After the completion of steps 402 to 414, the trading server 102 of trading system 100 may now calculate the price of a real estate index linked financial instrument (e.g. real estate index linked call option). Normally four parameters of equation (2), K, S, r, and t, can be figured with particularity. However, the volatility of a commodity (e.g., a stock or any other underlying asset, security or index), σ (sigma), cannot. With this parameter, human judgment comes into play to quantify. There are traditionally two methods for measuring volatility—historical and implied. This is where future movement of real estate indices must be considered.

As mentioned above, most models assume that, for example, last year's real estate cycles (and therefore the effect of those cycles upon the indices discussed heretofore in this document) will repeat from year to year. Historical analysis has shown, however, that this assumption does not always hold true. Thus, the present invention can make use of real estate predicted future index database 106 (in conjunction with real estate index history database 108) to arrive at a more accurate volatility calculation, and thus a better option price.

In step 416, a pricing model (e.g., the Black-Scholes pricing model of equation (2), or some other well-known pricing model) which has been modified to take into account both past and real estate predicted future index changes, is applied. The present invention contemplates four real estate index-related modifications to the Black-Scholes pricing model of equation (2) (such modifications can also be applied to other pricing models). First, the strike price, K, is the forecasted (i.e., predicted future) real estate index condition.

Second, because we are dealing with real estate indices and not an underlying stock with a quoted (i.e., market) price, the underlying commodity price, S, is the historical real estate index value for the geographic region for the time period between the start and maturity dates.

Third, the volatility σ, using the historical method, is the annualized standard deviation of the natural logarithm (ln) of the real estate index as called for in the contract. In a preferred embodiment of the present invention where the real estate index history database 108 includes data for twenty years, the volatility will be an annualized standard deviation of the measure of the real estate index over the past twenty years.

Fourth, as a consequence of the modifications mentioned above, the standard normal distribution function calculation of equations (4) and (5) is also modified. To account for real estate indices, N(d₁) is first calculated and then N(d₂) is set to the same value. This is done because many pricing models, including the Black-Scholes pricing model, are designed for commodities that fluctuate in price on a given day. That price may vary from minute to minute during active trading on an exchange (e.g., NYSE) and would be important in the valuation of an option for that commodity. However, because the present invention deals with real estate indices as the underlying commodity, the selected real estate index conditions fluctuations for a given day are not as relevant considering real estate index linked or real estate index-impacted financial instruments deal with average real estate index movements.

In equations (7) and (8) below, the sum n+1 represents the number of historical real estate index observations calculated from querying the real estate index history database 108. Thus, uᵢ is defined as the logarithm of the price S relative between two real estate index “prices” (i.e., historical real estate index measurements) Sᵢ and Sᵢ₋₁ and is expressed by equation (7):
uᵢ=ln(sᵢ/sᵢ₊₁) (7)

Thus, historical volatility, a, can be calculated using equation (8):

$${σ}^{2} = {\sum }_{i = 1}^{n} {( {u}_{i} - u )}^{2} \qquad ( 8 )$$

In equation (8), u is the mean of all real estate index observations. Finally, σ may then be computed by taking the square root of σ².

In step 418, trading system 100 may now output the “predicted future price of real estate index financial instruments” (i.e., C for a call-type real estate index linked option) for the real estate index linked financial transaction. That is, trading system 100 may publish a call option contract price for a particular period (i.e., between the start date and maturity date), for a particular geographic location (e.g., MSA), for a particular real estate index. The operation of trading system 100 is thus complete as indicated by step 420 of flowchart 400.

In an alternative embodiment, as will be apparent to one skilled in the relevant art(s) based on the teachings contained herein, trading server 102 of trading system 100 may operate in a manner where the volatility a is outputted when given the cost of a real estate index linked financial instrument contract C. Furthermore, the present invention contemplates an embodiment where standard inputs are entered into trading system 100 for given geographic location so that the relevant “Real Estate Index” value, in quote form or not in quote form, may be published in the information distribution medium 116. That is, a “Real Estate Index” value may be published in a information distribution medium 116 or other information distribution tools for a plurality of MSAs given an agreed upon set of inputs for a real estate index linked financial instrument or instruments. For example, the output of step 418 may be a “Real Estate Index Summary” (similar to the Dow™ Industrials or S&P™ 500) for future months for a particular MSA.

V. Detailed Example of System Operation

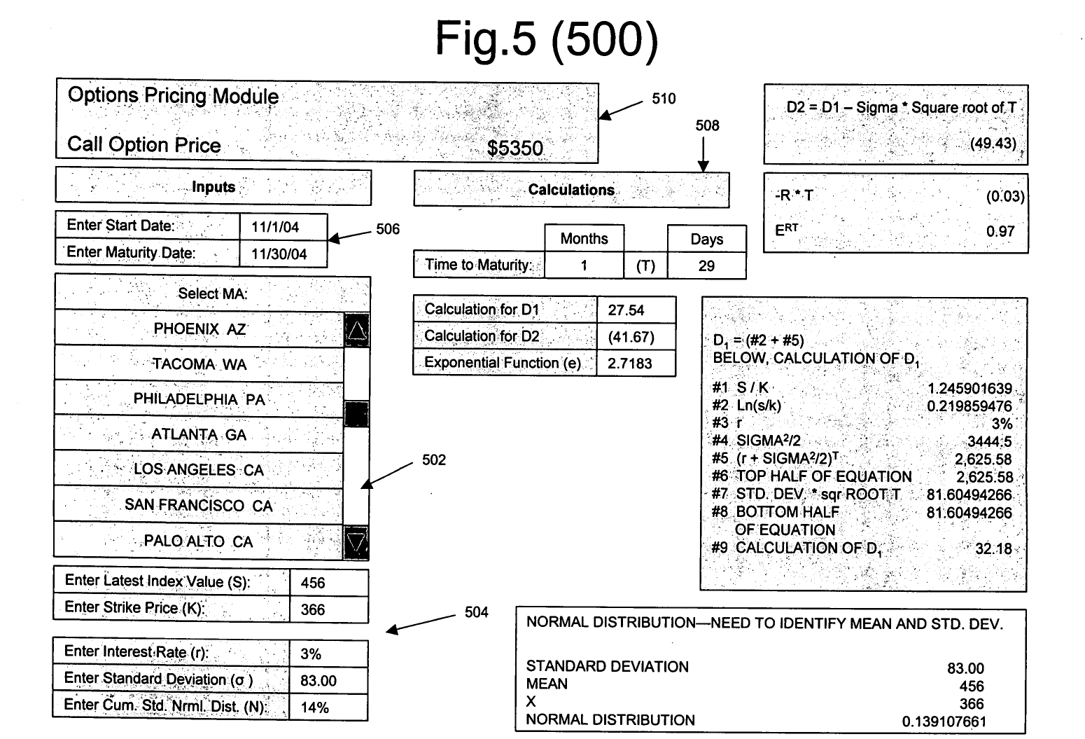

In an embodiment of the present invention, trading server 102 will provide a GUI (as shown in FIG. 5) for users, such as the in-house traders using the plurality of workstations 110, to enter inputs and receive the outputs as described in flowchart 400. Further, trading server 102 in conjunction with the web server 110 will also provide a GUI to the plurality of external users on the workstations 114 to enter inputs and receive the outputs as described in flowchart 400.

Still referring to FIG. 5, a detailed example of the operation of trading system 100 is presented in Table 2 below. Table 2 illustrates example numbers for each step of flowchart 400 presented in FIG. 4. In this example, as will be apparent to one skilled in the relevant art(s) based on the teachings contained herein, trading server 102 will use the real estate index data stored in databases 106 and 108 in calculating the relevant changes to real estate index linked financial instruments for steps 412 and 414, respectively.

A GUI screen 500 with the representative numbers in Table 2 is shown in FIG. 5. The GUI screen 500 includes a pull-down menu 502 listing each MSA for which the real estate index history database 108 and real estate predicted future index database 106 have available data and thus, trading system 100 may process a financial transaction for.

TABLE 2

| Step | Input(s)/Calculation(s) | Equation(s) |
|---|---|---|
| 404 | Start Date = 11/1/98 | |
| 406 | Maturity Date = 11/30/98 | |
| 408 | Metro Area = Washington, D.C. | |
| 409 | Currency = USD | |
| 410 | Interest Rate = 3% | |
| 412 | Latest Index Value = 456 | (2) |
| 414 | Strike Price = 366 | (2) |
| 416 | S = 456 | (2) |
| | K = 366 | (2) |
| | t = 29 days = 29/30 months = 0.9667 | |
| | r = 3% | |
| | e = 2.71828 | |
| | σ = 83 | (7) & (8) |
| | d₁ = [ln(S/K) + (r + σ²/2)^{t}]/σ√t | (3A) |
| | d₁ = 32.18 | |
| | d₂ = d₁ − σ√t = −49.43 | (3B) |
| | N(d₁) = 14% | (4) & (5) |
| | N(d₂) = 14% | |
| 418 | C = S*N(d₁) − Ke^{-(rt)} *N(d₂) = $4,486 | (2) |

The GUI screen 500 further includes a display 504 indicating the latest index value and strike price for the geographic location highlighted in the pull down menu 502. The real estate index information shown in display 504 is calculated from the real estate index history database 108 and real estate predicted future index database 106, respectively, after the user has used input boxes 506 to enter the contact start and maturity dates, respectively. GUI Screen 500 also includes calculation boxes 508 which show the various components of equation (3A) and equation (3B). Upon trading system 100 calculating equation (3A) and equation (3B), the call option price is displayed in a box 510 within the GUI screen 500.

VI. Environment

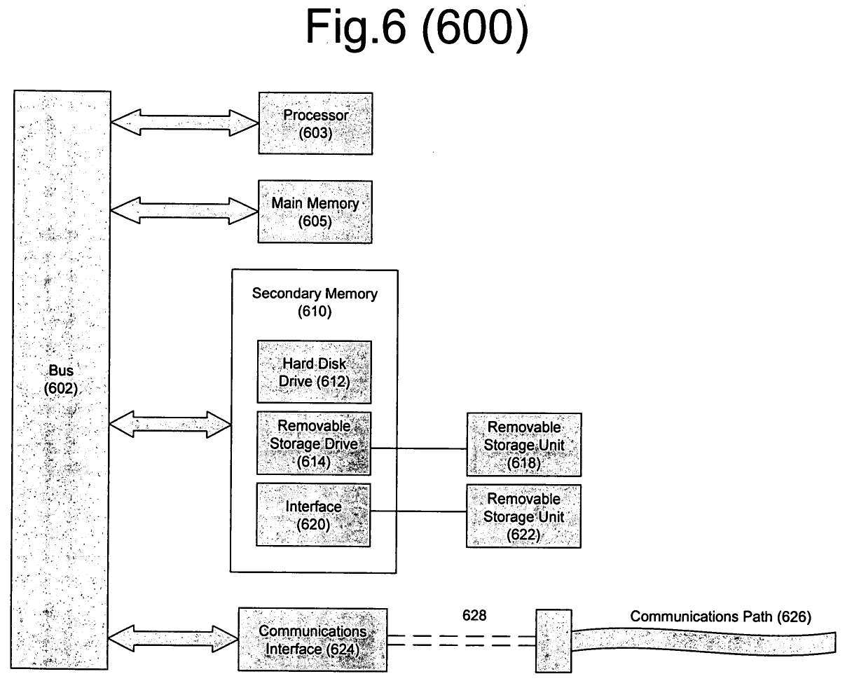

The present invention (i.e., trading system 100 or any part thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 600 is shown in FIG. 6. The computer system 600 includes one or more processors, such as processor 603. The processor 603 is connected to a communication bus 602. Various software embodiments are described in terms of this exemplary computer system. After reading this description, it will be apparent to a person skilled in the relevant art how to implement the invention using other computer systems and/or computer architectures.

Computer system 600 also includes a main memory 605, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a PCMCIA slot and card, etc. Software and data transferred via communications interface 624 are in the form of signals 628 which may be electronic, electromagnetic, optical or other signals capable of being received by communications interface 624. These signals 628 are provided to communications interface 624 via a communications path (i.e., channel) 626. This channel 626 carries signals 628 and may be implemented using wire or cable, fiber optics, a phone line, a cellular phone link, an RF link and other communications channels.

In this document, the term “computer program product” refers to removable storage units 618, 622, and signals 628. These computer program products are means for providing software to computer system 600. The invention is directed to such computer program products.

Computer programs (also called computer control logic) are stored in main memory 605, and/or secondary memory 610 and/or in computer program products. Computer programs may also be received via communications interface 624. Such computer programs, when executed, enable the computer system 600 to perform the features of the present invention as discussed herein. In particular, the computer programs, when executed, enable the processor 603 to perform the features of the present invention. Accordingly, such computer programs represent controllers of the computer system 600.

In an embodiment where the invention is implemented using software, the software may be stored in a computer program product and loaded into computer system 600 using at least one removable storage drive 614, hard drive 612 or communications interface 624. The control logic (software), when executed by the processor 603, causes the processor 603 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While preferred embodiments of the invention have been described and illustrated, it should be apparent that many modifications to the embodiments and implementations of the invention can be made without departing from the spirit or scope of the invention. For example, while only vanilla American options are explained in detail in the interest of simplicity, the same general approach can be applied to computing volatilities implied by exotic American options and/or American options with transaction costs and/or other varieties of options, as well as the inverse pricing of other financial instruments not described herein, such as, but not limited to, futures, forwards, swaps, swaptions, caps, floors, collars, corridors, notes, etc. The modules illustrated in FIG. 1 as making up trading system 100 may be one or more hardware, software, or hybrid components residing in (or distributed among) one or more local or remote computer systems. Although the modules are shown as physically separated components, it should be readily apparent that the modules may be combined or further separated into a variety of different components, sharing different resources (including processing units, memory, clock devices, software routines, etc.) as required for the particular implementation of the embodiment. Indeed, even a single general purpose computer executing a computer program to produce the functionality described herein may be utilized to implement the illustrated embodiments. A user interface device may be implemented to input and/or output information during an exchange of information between user and trading system 100. The user interface device may be implemented as a graphical user interface (GUI) containing a display or the like, or may be a link to other user input/output devices known in the art. The depiction of external users 114a to 114n is made to represent a variety of known users and the supporting systems that provide user access, such as networks and connected systems, i.e. local or wide area networks, a company intranet, systems providing Internet access, electronic communications network (ECNs), small order exchange systems (SOES), on-line brokers or other trading networks, or other such communications tools.

VII. Conclusion

While various embodiments of the present invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus, the present invention should not be limited by any of the above-described exemplary embodiments, but should be defined only in accordance with the following claims and their equivalents.

1. A method for creating and valuing financial instruments based upon real estate indices which compile real estate price information for localities, cities, regions, states, nations, or multinational/international areas.

2. The method of claim 1, where the future value of the financial instrument is calculated by inputting historical real estate index information and/or predicted future real estate index information and/or financial information, interest rate(s), currency denomination(s), and start date and date of expiry of each contract into a pricing model including but not limited to trinomial, binomial, Monte Carlo simulation, or Black-Scholes model.

3. The method of claim 2, wherein the financial instrument may be comprised of multiple financial instruments involving at least one financial instrument based upon a real estate index or indices, or is based upon multiple real estate indices, including but not limited to asset-backed securities, basket options, chooser options, option chains, or rainbow options.

4. A method for disseminating information for a financial instrument related to at least one real estate index, comprising the steps of:
a. quoting prices, historical real estate index information, predicted future real estate index information, and/or metrics (e.g. prices, open interest, 90-day volatility) on contracts of a real estate index linked financial instrument;
b. using an information distribution medium, either physical or electronic, to disseminate the information of claim a. to users of this information.

5. A computer-implemented method for creating and valuing a financial instrument based upon real estate indices which compile real estate price information for localities, cities, regions, states, nations, or multinational/international areas.

6. The method of claim 5, where the future value of the financial instrument is calculated by inputting historical real estate index information and/or predicted future real estate index information and/or financial information, interest rate(s), currency denomination(s), and start date and date of expiry of each contract into a pricing model including but not limited to trinomial, binomial, Monte Carlo simulation, or Black-Scholes model.

7. The method of claim 6, wherein the financial instrument may be comprised of multiple financial instruments involving at least one financial instrument based upon a real estate index or indices, or is based upon multiple real estate indices, including but not limited to asset-backed securities, basket options, chooser options, option chains, or rainbow options.

8. A computer-implemented method for determining the volatility of financial instruments based upon real estate indices which compile real estate price information for localities, cities, regions, states, nations, or multinational/international areas.

9. The method of claim 8, where the volatility of the financial instrument is calculated by inputting historical real estate index information and/or predicted future real estate index information and/or financial information, interest rate(s), currency denomination(s), and start date and date of expiry of each contract into a pricing model including but not limited to trinomial, binomial, Monte Carlo simulation, or Black-Scholes model.

10. The method of claim 9, wherein the financial instrument may be comprised of multiple financial instruments involving at least one financial instrument based upon a real estate index or indices, or is based upon multiple real estate indices, including but not limited to asset-backed securities, basket options, chooser options, option chains, or rainbow options.

11. A computer system for creating and valuing a financial instrument based upon real estate indices which compile real estate price information for localities, cities, regions, states, nations, or multinational/international areas, comprising:
a. a computer connected to a real estate index history database and/or a real estate predicted future index database and/or financial database that creates and values a financial instrument under conditions where the future value of the financial instrument is calculated by inputting historical real estate index information and/or predicted future real estate index information and/or financial information, interest rate(s), currency denomination(s), and start date and date of expiry of each contract into a pricing model including but not limited to trinomial, binomial, Monte Carlo simulation, or Black-Scholes model.
b. at least one workstation that allows a user to specify inputs that affect the value of the financial instrument.

12. A computer program product comprising a computer-usable medium havingcontrol logic stored therein for causing a computer to perform valuation of real estate index linked financial instruments, the control logic comprising:
a. a computer readable program code means that causes the computer to create and value a financial instrument based upon indices which compile real estate price information for localities, cities, regions, states, nations, or multinational/international areas.
b. a computer readable program code means for valuing a financial instrument based upon real estate indices by inputting historical real estate index information and/or predicted future real estate index information and/or financial information, interest rate(s), currency denomination(s), start date and date of expiry of each contract, and/or cost of the financial instrument into a pricing model including but not limited to trinomial, binomial, Monte Carlo simulation, or Black-Scholes model.
c. the method of claim b., where the future value of the financial instrument is a defined currency amount and the initial value is calculated by utilizing computer readable program code for applying a pricing model using historical real estate index information and/or predicted future real estate index information and/or financial information, interest rate(s), currency denomination(s), and start date and date of expiry of each contract.
